(19) United States
(12) Patent Application Publication
(10) Pub. No.: US 2025/0157455 A1
(43) Pub. Date: May 15, 2025

(54) Reverberation Level Compensation

(71) Applicant: Nokia Technologies Oy, Espoo (FI)

(72) Inventor: Antti Johannes ERONEN, Tampere (FI)

(21) Appl. No.: 18/838,277

(22) PCT Filed: Jan. 30, 2023
(86) PCT No.: PCT/FI2023/050058

§ 371 Date: Aug. 14, 2024

(30) Foreign Application Priority Data
Feb. 24, 2022 (GB) 2202583.7

(51) Int. Cl. G10K 15/08; H04S 7/00

(52) U.S. Cl. CPC G10K 15/08; H04S 7/303

(57) ABSTRACT

An apparatus for assisting spatial rendering in at least one acoustic environment, the apparatus including circuitry configured to: determine a source-listener distance; determine an attenuation parameter value, the attenuation parameter associated with the source-listener distance; determine an average attenuation parameter value associated with at least one acoustic environment; determine a compensated attenuation parameter value based on the average attenuation parameter value and the attenuation parameter value; obtain an input signal; and generate a late reverberation audio signal part by applying a reverberator to the input signal, the reverberator configured with the compensated attenuation parameter value to compensate within the reverberation level for the attenuation parameter value associated with the source-listener distance.

### FIELD

The present application relates to apparatus and methods for adjustment and/or compensation of reverberation level, but not exclusively for spatial audio reproduction in augmented reality and/or virtual reality apparatus.

### BACKGROUND

Reverberation refers to the persistence of sound in a space after the actual sound source has stopped. Different spaces are characterized by different reverberation characteristics. For conveying spatial impression of an environment, reproducing reverberation perceptually accurately is important. Room acoustics are often modelled with individually synthesized early reflection portion and a statistical model for the diffuse late reverberation. FIG. 1 depicts an example of a synthesized room impulse response where the direct sound 101 is followed by discrete early reflections 103 which have a direction of arrival (DOA) and diffuse late reverberation 105 which can be synthesized without any specific direction of arrival. The delay d1(t) 102 in FIG. 1 can be seen to denote the direct sound arrival delay from the source to the listener and the delay d2(t) 104 can denote the delay from the source to the listener for one of the early reflections (in this case the first arriving reflection).

One method of reproducing reverberation is to utilize a set of N loudspeakers (or virtual loudspeakers reproduced binaurally using a set of head-related transfer functions (HRTF)). The loudspeakers are positioned around the listener somewhat evenly. Mutually incoherent reverberant signals are reproduced from these loudspeakers, producing a perception of surrounding diffuse reverberation.

The reverberation produced by the different loudspeakers has to be mutually incoherent. In a simple case the reverberations can be produced using the different channels of the same reverberator, where the output channels are uncorrelated but otherwise share the same acoustic characteristics such as RT60 time and level (specifically, the diffuse-to-direct ratio or reverberant-to-direct ratio). Such uncorrelated outputs sharing the same acoustic characteristics can be obtained, for example, from the output taps of a Feedback-Delay-Network (FDN) reverberator with suitable tuning of the delay line lengths, or from a reverberator based on using decaying uncorrelated noise sequences by using a different uncorrelated noise sequence in each channel. In this case, the different reverberant signals effectively have the same features, and the reverberation is typically perceived to be similar to all directions.

Reverberation spectrum or level can be controlled using the diffuse-to-direct ratio (DDR), which describes the ratio of the energy (or level) of reverberant sound energy to the direct sound energy (or the total emitted energy of a sound source).

### SUMMARY

There is provided according to a first aspect an apparatus for assisting spatial rendering in at least one acoustic environment, the apparatus comprising means configured to: determine a source-listener distance; determine an attenuation parameter value, the attenuation parameter associated with the source-listener distance; determine an average attenuation parameter value associated with at least one acoustic environment; determine a compensated attenuation parameter value based on the average attenuation parameter value and the attenuation parameter value; obtain an input signal; and generate a late reverberation audio signal part by applying a reverberator to the input signal, the reverberator configured with the compensated attenuation parameter value to compensate within the reverberation level for the attenuation parameter value associated with the source-listener distance.

The means may be further configured to obtain acoustic environment geometry associated with the at least one acoustic environment, wherein the means configured to determine the average attenuation parameter value associated with the at least one acoustic environment may be configured to determine the average attenuation parameter value based on the at least one audio environment geometry.

The means configured to determine the average attenuation parameter value associated with the at least one audio environment geometry may be configured to: determine an average distance between two points in the at least one audio environment geometry; and determine the average attenuation parameter value based on the at least one audio environment geometry based on the average distance.

The means configured to determine the average distance between two points in the at least one audio environment geometry may be configured to apply one of: a closed form expression to calculate the average distance of two points in a geometric shape associated with the at least one audio environment geometry; and a sampling procedure to simulate possible source and listener positions in the at least one audio environment geometry.

The means configured to determine the average attenuation parameter value associated with the at least one acoustic environment may be configured to receive the average attenuation parameter value.

The means configured to determine the average attenuation parameter value associated with the at least one acoustic environment may be configured to: receive the average distance of the at least one acoustic environment; and determine the average attenuation parameter value associated with the at least one acoustic environment based on the received average distance.

The means configured to determine the average attenuation parameter value associated with the at least one acoustic environment may be configured to: receive attenuation parameter values associated with a plurality of sampled source-listener positions within the at least one acoustic environment; and determine the average attenuation parameter value associated with the at least one acoustic environment based on an arithmetic or geometric mean of the received attenuation parameter values.

The means configured to determine an attenuation parameter value associated with the source-listener distance may be configured to determine the attenuation parameter value based on the source-listener distance.

The means configured to determine the source-listener distance may be configured to: obtain at least one of the source or the listener position from metadata associated with the at least one audio environment; and select between three dimension or two dimension at least one audio environment geometry when calculating the source-listener distance.

The means configured to generate a late reverberation audio signal part by applying a reverberator to the input signal, the reverberator configured to compensate within the reverberation level for the attenuation parameter value associated with the source-listener distance may be configured to: determine a source-listener distance dependent gain for the reverberator for compensating the average attenuation parameter value.

The means configured to generate a late reverberation audio signal part by applying a reverberator to the input signal, the reverberator configured to compensate within the reverberation level for the attenuation parameter value associated with the source-listener distance may be configured to: adjust a ratio parameter based on the average attenuation parameter value in the at least one acoustic environment; and apply the reverberator to a part of the input signal, the part of the input signal based on a filter applied to the input signal configured by the ratio parameter or based on the ratio parameter.

The means may be further configured to obtain a bitstream, wherein the bitstream may comprise information of the amount of average distance gain attenuation, wherein the means configured to determine the average attenuation parameter value based on the at least one audio environment geometry may be further configured to determine the average attenuation parameter value based on the information of the amount of average distance gain attenuation.

According to a second aspect there is provided an apparatus for assisting spatial rendering in at least one acoustic environments, the apparatus comprising means configured to: obtain acoustic environment geometry associated with the at least one acoustic environment; determine an average attenuation parameter value associated with the at least one acoustic environment; generate a bitstream associated with the average attenuation parameter value, wherein the bitstream is to be employed in assisting a configuration of a reverberator within the spatial rendering.

The means may be further configured to determine an average distance associated with the at least one audio environment geometry, and wherein the means configured to determine the average attenuation parameter value associated with the at least one acoustic environment may be configured to determine the average attenuation parameter value based on the average distance.

The means configured to determine the average distance associated with the at least one audio environment geometry may be configured to apply one of: a closed form expression to calculate the average distance of two points in a geometric shape associated with the at least one audio environment geometry; and a sampling procedure to simulate possible source and listener positions in the at least one audio environment geometry.

The means configured to determine the average distance between two points in the at least one audio environment geometry may be configured to select between a three dimensional or two dimensional geometry when calculating the average distance between two points in the at least one audio environment geometry.

The bitstream may comprise the average attenuation parameter value.

The means may further be configured to: determine parameters for a diffuse-to-direct ratio control filter for the reverberator within the spatial rendering; and adjust the parameters for the diffuse-to-direct ratio control filter based on the average attenuation parameter value, wherein the bitstream comprises the adjusted parameters for the diffuse-to-direct ratio control filter.

According to a third aspect there is provided a method for an apparatus for assisting spatial rendering in at least one acoustic environment, the method comprising: determining a source-listener distance; determining an attenuation parameter value, the attenuation parameter associated with the source-listener distance; determining an average attenuation parameter value associated with at least one acoustic environment; determining a compensated attenuation parameter value based on the average attenuation parameter value and the attenuation 25 parameter value; obtaining an input signal; and generating a late reverberation audio signal part by applying a reverberator to the input signal, the reverberator configured with the compensated attenuation parameter value to compensate within the reverberation level for the attenuation parameter value associated with the source-listener distance.

30 The method may further comprise obtaining acoustic environment geometry associated with the at least one acoustic environment, wherein determining the average attenuation parameter value associated with the at least one acoustic environment may comprise determining the average attenuation parameter value based on the at least one audio environment geometry.

Determining the average attenuation parameter value associated with the at least one audio environment geometry may comprise: determining an average distance between two points in the at least one audio environment geometry; and determining the average attenuation parameter value based on the at least one audio environment geometry based on the average distance.

Determining the average distance between two points in the at least one audio environment geometry may comprise applying one of: a closed form expression to calculate the average distance of two points in a geometric shape associated with the at least one audio environment geometry; and a sampling procedure to simulate possible source and listener positions in the at least one audio environment geometry.

Determining the average attenuation parameter value associated with the at least one acoustic environment may comprise receiving the average attenuation parameter value.

Determining the average attenuation parameter value associated with the at least one acoustic environment may comprise: receiving the average distance of the at least one acoustic environment; and determining the average attenuation parameter value associated with the at least one acoustic environment based on the received average distance.

Determining the average attenuation parameter value associated with the at least one acoustic environment may comprise: receiving attenuation parameter values associated with a plurality of sampled source-listener positions within the at least one acoustic environment; and determining the average attenuation parameter value associated with the at least one acoustic environment based on an arithmetic or geometric mean of the received attenuation parameter values.

Determining an attenuation parameter value associated with the source-listener distance may comprise determining the attenuation parameter value based on the source-listener distance.

Determining the source-listener distance may comprise: obtaining at least one of the source or the listener position from metadata associated with the at least one audio environment; and selecting between three dimension or two dimension at least one audio environment geometry when calculating the source-listener distance.

Generating a late reverberation audio signal part by applying a reverberator to the input signal, the reverberator configured to compensate within the reverberation level for the attenuation parameter value associated with the source-listener distance may comprise: determining a source-listener distance dependent gain for the reverberator for compensating the average attenuation parameter value.

Generating a late reverberation audio signal part by applying a reverberator to the input signal, the reverberator configured to compensate within the reverberation level for the attenuation parameter value associated with the source-listener distance may comprise: adjusting a ratio parameter based on the average attenuation parameter value in the at least one acoustic environment; and applying the reverberator to a part of the input signal, the part of the input signal based on a filter applied to the input signal configured by the ratio parameter or based on the ratio parameter.

The method may further comprise obtaining a bitstream, wherein the bitstream may comprise information of the amount of average distance gain attenuation, wherein determining the average attenuation parameter value based on the at least one audio environment geometry may further comprise determining the average attenuation parameter value based on the information of the amount of average distance gain attenuation.

According to a fourth aspect there is provided a method for an apparatus for assisting spatial rendering in at least one acoustic environments, the method comprising: obtaining acoustic environment geometry associated with the at least one acoustic environment; determining an average attenuation parameter value associated with the at least one acoustic environment; generating a bitstream associated with the average attenuation parameter value, wherein the bitstream is to be employed in assisting a configuration of a reverberator within the spatial rendering.

The method may further comprise determining an average distance associated with the at least one audio environment geometry, and wherein determining the average attenuation parameter value associated with the at least one acoustic environment may comprise determining the average attenuation parameter value based on the average distance.

Determining the average distance associated with the at least one audio environment geometry may comprise applying one of: a closed form expression to calculate the average distance of two points in a geometric shape associated with the at least one audio environment geometry; and a sampling procedure to simulate possible source and listener positions in the at least one audio environment geometry.

Determining the average distance between two points in the at least one audio environment geometry may comprise selecting between a three dimensional or two dimensional geometry when calculating the average distance between two points in the at least one audio environment geometry.

The bitstream may comprise the average attenuation parameter value.

The method may further comprise: determining parameters for a diffuse-to-direct ratio control filter for the reverberator within the spatial rendering; and adjusting the parameters for the diffuse-to-direct ratio control filter based on the average attenuation parameter value, wherein the bitstream comprises the adjusted parameters for the diffuse-to-direct ratio control filter.

According to a fifth aspect there is provided an apparatus the apparatus comprising at least one processor and at least one memory including a computer program code, the at least one memory and the computer program code configured to, with the at least one processor, cause the apparatus at least to: determine a source-listener distance; determine an attenuation parameter value, the attenuation parameter associated with the source-listener distance; determine an average attenuation parameter value associated with at least one acoustic environment; determine a compensated attenuation parameter value based on the average attenuation parameter value and the attenuation parameter value; obtain an input signal; and generate a late reverberation audio signal part by applying a reverberator to the input signal, the reverberator configured with the compensated attenuation parameter value to compensate within the reverberation level for the attenuation parameter value associated with the source-listener distance.

The apparatus may be further caused to obtain acoustic environment geometry associated with the at least one acoustic environment, wherein the apparatus caused to determine the average attenuation parameter value associated with the at least one acoustic environment may be caused to determine the average attenuation parameter value based on the at least one audio environment geometry.

The apparatus caused to determine the average attenuation parameter value associated with the at least one audio environment geometry may be caused to: determine an average distance between two points in the at least one audio environment geometry; and determine the average attenuation parameter value based on the at least one audio environment geometry based on the average distance.

The apparatus caused to determine the average distance between two points in the at least one audio environment geometry may be caused to apply one of: a closed form expression to calculate the average distance of two points in a geometric shape associated with the at least one audio environment geometry; and a sampling procedure to simulate possible source and listener positions in the at least one audio environment geometry.

The apparatus caused to determine the average attenuation parameter value associated with the at least one acoustic environment may be caused to receive the average attenuation parameter value.

The apparatus caused to determine the average attenuation parameter value associated with the at least one acoustic environment may be caused to: receive the average distance of the at least one acoustic environment; and determine the average attenuation parameter value associated with the at least one acoustic environment based on the received average distance.

The apparatus caused to determine the average attenuation parameter value associated with the at least one acoustic environment may be caused to: receive attenuation parameter values associated with a plurality of sampled source-listener positions within the at least one acoustic environment; and determine the average attenuation parameter value associated with the at least one acoustic environment based on an arithmetic or geometric mean of the received attenuation parameter values.

The apparatus caused to determine an attenuation parameter value associated with the source-listener distance may be caused to determine the attenuation parameter value based on the source-listener distance.

The apparatus caused to determine the source-listener distance may be caused to: obtain at least one of the source or the listener position from metadata associated with the at least one audio environment; and select between three dimension or two dimension at least one audio environment geometry when calculating the source-listener distance.

The apparatus caused to generate a late reverberation audio signal part by applying a reverberator to the input signal, the reverberator configured to compensate within the reverberation level for the attenuation parameter value associated with the source-listener distance may be caused to: determine a source-listener distance dependent gain for the reverberator for compensating the average attenuation parameter value.

The apparatus caused to generate a late reverberation audio signal part by applying a reverberator to the input signal, the reverberator configured to compensate within the reverberation level for the attenuation parameter value associated with the source-listener distance may be caused to: adjust a ratio parameter based on the average attenuation parameter value in the at least one acoustic environment; and apply the reverberator to a part of the input signal, the part of the input signal based on a filter applied to the input signal configured by the ratio parameter or based on the ratio parameter.

The apparatus may be further caused to obtain a bitstream, wherein the bitstream may comprise information of the amount of average distance gain attenuation, wherein the apparatus caused to determine the average attenuation parameter value based on the at least one audio environment geometry may be further caused to determine the average attenuation parameter value based on the information of the amount of average distance gain attenuation.

According to a sixth aspect there is provided an apparatus the apparatus comprising at least one processor and at least one memory including a computer program code, the at least one memory and the computer program code configured to, with the at least one processor, cause the apparatus at least to: obtain acoustic environment geometry associated with the at least one acoustic environment; determine an average attenuation parameter value associated with the at least one acoustic environment; generate a bitstream associated with the average attenuation parameter value, wherein the bitstream is to be employed in assisting a configuration of a reverberator within the spatial rendering.

The apparatus may be further caused to determine an average distance associated with the at least one audio environment geometry, and wherein the apparatus caused to determine the average attenuation parameter value associated with the at least one acoustic environment may be caused to determine the average attenuation parameter value based on the average distance.

The apparatus caused to determine the average distance associated with the at least one audio environment geometry may be caused to apply one of: a closed form expression to calculate the average distance of two points in a geometric shape associated with the at least one audio environment geometry; and a sampling procedure to simulate possible source and listener positions in the at least one audio environment geometry.

The apparatus caused to determine the average distance between two points in the at least one audio environment geometry may be caused to select between a three dimensional or two dimensional geometry when calculating the average distance between two points in the at least one audio environment geometry.

The bitstream may comprise the average attenuation parameter value.

The apparatus may further be caused to: determine parameters for a diffuse-to-direct ratio control filter for the reverberator within the spatial rendering; and adjust the parameters for the diffuse-to-direct ratio control filter based on the average attenuation parameter value, wherein the bitstream comprises the adjusted parameters for the diffuse-to-direct ratio control filter.

According to a seventh aspect there is provided an apparatus for assisting spatial rendering in at least one acoustic environment, the apparatus comprising: determining circuitry configured to determine a source-listener distance; determining circuitry configured to determine an attenuation parameter value, the attenuation parameter associated with the source-listener distance; determining circuitry configured to determine an average attenuation parameter value associated with at least one acoustic environment; determining circuitry configured to determine a compensated attenuation parameter value based on the average attenuation parameter value and the attenuation parameter value; obtaining circuitry configured to obtain an input signal; and generating circuitry configured to generate a late reverberation audio signal part by applying a reverberator to the input signal, the reverberator configured with the compensated attenuation parameter value to compensate within the reverberation level for the attenuation parameter value associated with the source-listener distance.

According to an eighth aspect there is provided an apparatus comprising: obtaining circuitry configured to obtain acoustic environment geometry associated with the at least one acoustic environment; determining circuitry configured to determine an average attenuation parameter value associated with the at least one acoustic environment; generating circuitry configured to generate a bitstream associated with the average attenuation parameter value, wherein the bitstream is to be employed in assisting a configuration of a reverberator within the spatial rendering.

According to a ninth aspect there is provided a computer program comprising instructions [or a computer readable medium comprising program instructions] for causing an apparatus to perform at least the following: determine a source-listener distance; determine an attenuation parameter value, the attenuation parameter associated with the source-listener distance; determine an average attenuation parameter value associated with at least one acoustic environment; determine a compensated attenuation parameter value based on the average attenuation parameter value and the attenuation parameter value; obtain an input signal; and generate a late reverberation audio signal part by applying a reverberator to the input signal, the reverberator configured with the compensated attenuation parameter value to compensate within the reverberation level for the attenuation parameter value associated with the source-listener distance.

According to a tenth aspect there is provided a computer program comprising instructions [or a computer readable medium comprising program instructions] for causing an apparatus to perform at least the following: obtain acoustic environment geometry associated with the at least one acoustic environment; determine an average attenuation parameter value associated with the at least one acoustic environment; generate a bitstream associated with the average attenuation parameter value, wherein the bitstream is to be employed in assisting a configuration of a reverberator within the spatial rendering.

According to an eleventh aspect there is provided a non-transitory computer readable medium comprising program instructions for causing an apparatus to perform at least the following: determine a source-listener distance; determine an attenuation parameter value, the attenuation parameter associated with the source-listener distance; determine an average attenuation parameter value associated with at least one acoustic environment; determine a compensated attenuation parameter value based on the average attenuation parameter value and the attenuation parameter value; obtain an input signal; and generate a late reverberation audio signal part by applying a reverberator to the input signal, the reverberator configured with the compensated attenuation parameter value to compensate within the reverberation level for the attenuation parameter value associated with the source-listener distance.

According to a twelfth aspect there is provided a non-transitory computer readable medium comprising program instructions for causing an apparatus to perform at least the following: obtain acoustic environment geometry associated with the at least one acoustic environment; determine an average attenuation parameter value associated with the at least one acoustic environment; generate a bitstream associated with the average attenuation parameter value, wherein the bitstream is to be employed in assisting a configuration of a reverberator within the spatial rendering.

According to a thirteenth aspect there is provided an apparatus comprising: means for determining a source-listener distance; means for determining an attenuation parameter value, the attenuation parameter associated with the source-listener distance; means for determining an average attenuation parameter value associated with at least one acoustic environment; means for determining a compensated attenuation parameter value based on the average attenuation parameter value and the attenuation parameter value; mean for obtaining an input signal; and means for generating a late reverberation audio signal part by applying a reverberator to the input signal, the reverberator configured with the compensated attenuation parameter value to compensate within the reverberation level for the attenuation parameter value associated with the source-listener distance.

According to a fourteenth aspect there is provided an apparatus comprising: means for obtaining acoustic environment geometry associated with the at least one acoustic environment; means for determining an average attenuation parameter value associated with the at least one acoustic environment; means for generating a bitstream associated with the average attenuation parameter value, wherein the bitstream is to be employed in assisting a configuration of a reverberator within the spatial rendering.

According to a fifteenth aspect there is provided a computer readable medium comprising program instructions for causing an apparatus to perform at least the following: determine a source-listener distance; determine an attenuation parameter value, the attenuation parameter associated with the source-listener distance; determine an average attenuation parameter value associated with at least one acoustic environment; determine a compensated attenuation parameter value based on the average attenuation parameter value and the attenuation parameter value; obtain an input signal; and generate a late reverberation audio signal part by applying a reverberator to the input signal, the reverberator configured with the compensated attenuation parameter value to compensate within the reverberation level for the attenuation parameter value associated with the source-listener distance.

According to a sixteenth aspect there is provided a computer readable medium comprising program instructions for causing an apparatus to perform at least the following: obtain acoustic environment geometry associated with the at least one acoustic environment; determine an average attenuation parameter value associated with the at least one acoustic environment; generate a bitstream associated with the average attenuation parameter value, wherein the bitstream is to be employed in assisting a configuration of a reverberator within the spatial rendering.

An apparatus comprising means for performing the actions of the method as described above.

An apparatus configured to perform the actions of the method as described above.

A computer program comprising program instructions for causing a computer to perform the method as described above.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIG. 1 shows a model of room acoustics and the room impulse response;

FIG. 2 shows an example environment within which embodiments can be implemented showing an audio scene with an audio portal or acoustic coupling;

FIG. 3 shows schematically an example apparatus within which some embodiments may be implemented;

FIG. 4 shows a flow diagram of the operation of the example apparatus as shown in FIG. 3;

FIG. 5 shows schematically an example reverberator controller as shown in FIG. 3 according to some embodiments;

FIG. 6 shows a flow diagram of the operation of the example reverberator controller as shown in FIG. 5;

FIG. 7 shows schematically an example reverberator output signals spatialization controller as shown in FIG. 3 according to some embodiments;

FIG. 8 shows a flow diagram of the operation of the example reverberator output signals spatialization controller as shown in FIG. 7;

FIG. 9 shows schematically an example reverberator output signals spatializer as shown in FIG. 3 according to some embodiments;

FIG. 10 shows a flow diagram of the operation of the example Reverberator output signals spatializer as shown in FIG. 9;

FIG. 11 shows schematically an example FDN reverberator as shown in FIG. 3 according to some embodiments;

FIG. 12 shows schematically an example apparatus with transmission and/or storage within which some embodiments can be implemented; and

FIG. 13 shows an example device suitable for implementing the apparatus shown in previous figures.

### EMBODIMENTS OF THE APPLICATION

The following describes in further detail suitable apparatus and possible mechanisms for parameterizing and rendering audio scenes with reverberation.

As discussed above reverberation can be rendered using, e.g., a Feedback-Delay-Network (FDN) reverberator with a suitable tuning of delay line lengths. An FDN allows to control the reverberation times (RT60) and the energies of different frequency bands individually. Thus, it can be used to render the reverberation based on the characteristics of the room or modelled space. The reverberation times and the energies of the different frequencies are affected by the frequency-dependent absorption characteristics of the room.

As described above the reverberation spectrum or level can be controlled using a diffuse-to-direct ratio, which describes the ratio of the energy (or level) of reverberant sound energy to the direct sound energy (or the total emitted energy of a sound source). In ISO/IEC JTC1/SC29/WG6 N00054 MPEG-I Immersive Audio Encoder Input Format, the input to the encoder is provided as DDR value which indicates the ratio of the diffuse (reverberant) sound energy to the total emitted energy of a sound source. Another well-known measure is the RDR which refers to reverberant-to-direct ratio and which can be measured from an impulse response. The relation between these two, described in ISO/IEC JTC1/SC29/WG6 N0083 MPEG-I Immersive Audio CfP Supplemental Information, Recommendations and Clarifications, Version 1, is that

$$10 * log 10 ( D D R ) = 10 * log 10 ( R D R ) - 41 dB .$$

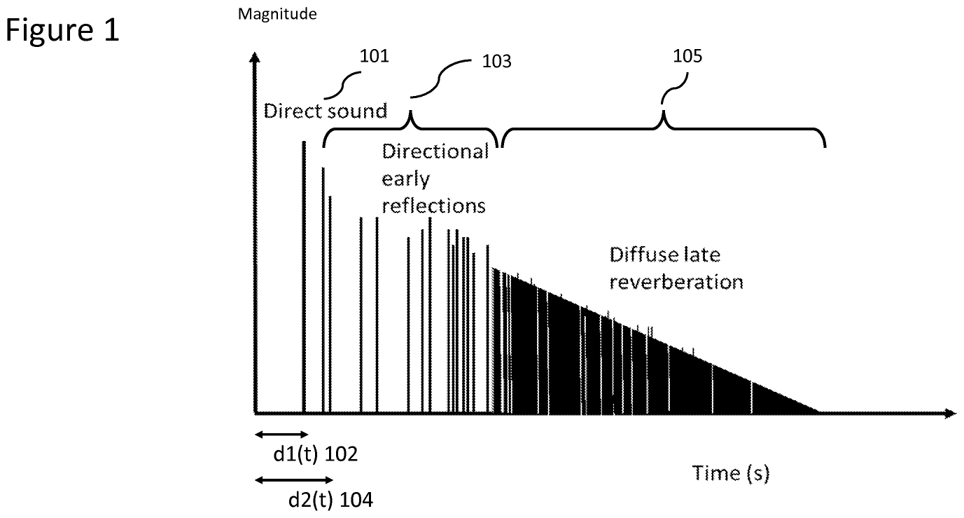

Referring to FIG. 1, the RDR can be calculated by
summing the squares of the sample values of the diffuse late reverberation portion 105
summing the squares of the sample values of the direct sound portion 101
calculating the ratio of these two sums to give the RDR.

The logarithmic RDR can be obtained as 10*log 10 (RDR).

In a virtual environment for virtual reality (VR) or a real physical environment for augmented reality (AR) there can be several acoustic environments, each with their own reverberation parameters which can be different in different acoustic environments.

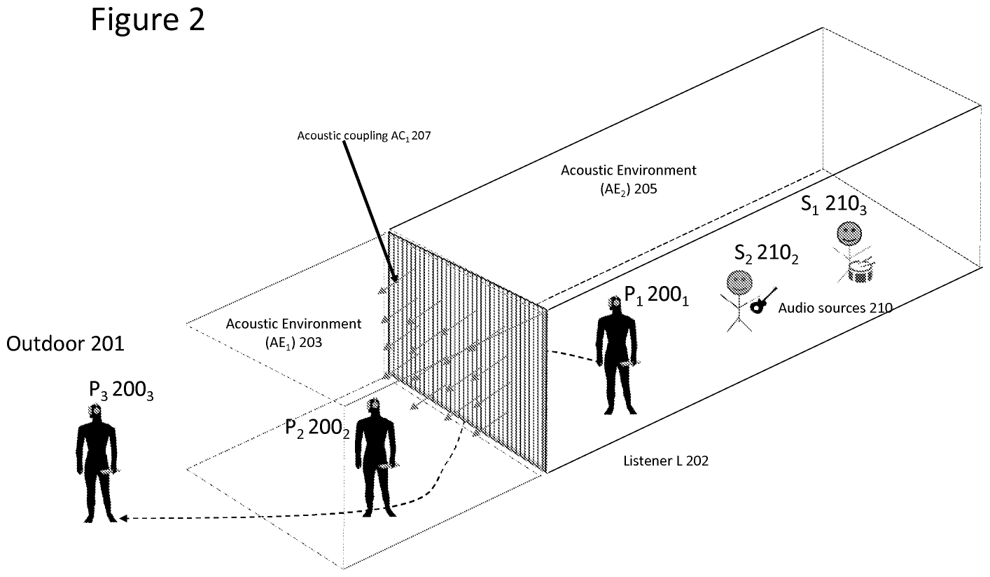

An example of such an environment is shown in FIG. 2. In this example there is shown the audio scene comprising a first acoustic environment AE₁ 203, a second acoustic environment AE₂ 205 and outdoor 201. There is shown an acoustic coupling AC₁ 207 between the first acoustic environment AE₁ 203 and a second acoustic environment AE₂ 205.

In this example the sound or audio sources 210 are located within the second acoustic environment AE₂ 205. In this example the audio sources 210 comprise a first audio source, a drummer, S₁ 210₃ and a second audio source, a guitarist, S₂ 210₂. The Listener 202 is further shown moving through the audio scene and is shown in the first acoustic environment AE₁ 203 at position P₁ 200₁, in the second acoustic environment AE₂ 205 at position P₂ 200₂ and outdoor 201 at position P₃ 200₃.

A reverberation level within the acoustic environment and implemented by the reverberator can additionally be controlled by a distance gain attenuation parameter. The distance gain attenuation parameter is typically less than the 1/distance rolloff applied for direct source rendering. In some circumstances the parameter can be of the order of 1-2 decibels per distance doubling.

The application of distance attenuation of late reverberation increases the realism of reverberation rendering for virtual or augmented reality, see for example, Vincent Martin, Isabelle Viaud-Delmon, Olivier Warusfel. Source distance modelling in the context of Audio Augmented Reality. Forum Acusticum, December 2020, Lyon, France. pp. 1369-1376, 10.48465/fa.2020.0759. hal-03235359. This is because real rooms are not fully diffuse because of their uneven absorption properties and therefore reverberation level is not constant throughout the space.

When an amount of distance gain attenuation is applied to the late reverberation this can produce the situation where the overall reverberation level can become too low in some parts of the scene. Thus, for example, in circumstances where the listener is particularly far away from the sound sources as the distance gain attenuation is source dependent. This attenuated level may be too far from the reverberation level provided by the content creator as RDR or DDR parameters. Therefore, there is a need for a method to compensate for the average level attenuation caused by distance dependent reverberation gain adjustment.

Control of activating/prioritizing reverberators is described in GB2200043.4, which specifically discusses a mechanism of prioritizing reverberators and activating only a subset of them based on the prioritization. GB2200335.4 furthermore describes a method to adjust reverberation level especially in augmented reality (AR) rendering. WO2021186107 describes late reverb modelling from acoustic environment information using FDNs and specifically describes designing a DDR filter to adjust the late reverb level based on input DDR data. GB2020673.6 describes a method and apparatus for fusion of virtual scene description in bitstream and listener space description for 6DoF rendering and specifically for late reverberation modelling for immersive audio scenes where the acoustic environment is a combination of content creator specified virtual scene as well as listener-consumption-space influenced listening space parameters. Thus, this background describes a method for rendering in AR audio scene comprising virtual scene description acoustic parameters and real-world listening-space acoustic parameters. GB2101657.1 describes late reverb rendering filter parameters are derived for a low latency renderer application. GB2116093.2 discusses reproduction of diffuse reverberation where a method is proposed that enables the reproduction of rotatable diffuse reverberation where the characteristics of the reverberation may be directionally dependent (i.e., having different reverberation characteristics in different directions) using a number of processing paths (at least 3, typically 6-20 paths) (virtual) multichannel signals by determining at least two panning gains based on a target direction and the positions of the (virtual) loudspeakers in a (virtual) loudspeaker set (e.g., using VBAP), obtaining mutually incoherent reverberant signals for each of the determined gains (e.g., using outputs of two reverberators tuned to produce mutually incoherent outputs, or using decorrelators), applying the determined gains for the corresponding obtained reverberant signals in order to obtain reverberant multichannel signals, combining the reverberant multichannel signals from the different processing paths, and reproducing the combined reverberant multichannel signals from the corresponding (virtual) loudspeakers. GB2115533.8 discusses a method for seamless listener transition between acoustic environments.

The concept as discussed in the embodiments relates to reproduction of late reverberation in 6DoF audio rendering systems based on acoustic scene reverberation parameters based on acoustic scene geometry. In these embodiments the reverberator is configured to enable compensation of average attenuation caused by source-listener distance dependent decay of reverberation level to adjust reverberation level in rendering for the acoustic scene geometry in order to provide improved realism of reverberation rendering.

This can in some embodiments be accomplished by apparatus and methods configured to implement the following method steps:
obtaining scene geometry;
based on the scene geometry, obtaining average attenuation caused by source-listener distance dependent decay of reverberation level;
obtaining an input signal; and
   rendering late reverberation with a reverberator using the input signal while compensating for the average attenuation in adjustment of reverberation level.

In some embodiments, the apparatus and methods are configured to calculate an average distance between two points in the scene geometry and obtain average source-listener distance based gain attenuation based on the average distance and then perform the compensation based on the average source-listener distance gain.

In some embodiments, the determination or calculating of the average distance involves at least one of:
using a closed form expression to calculate the average distance of two points in a geometric shape associated with the scene geometry;
performing a sampling procedure to simulate possible source and listener positions in the scene geometry;
obtaining at least one of source or listener position from metadata associated with the scene;
selecting between 3D or 2D scene geometry when calculating the average distance.

In some embodiments, the method determines or calculates a source-listener distance dependent gain while compensating for the average distance gain attenuation.

In some embodiments, the apparatus and methods are configured to adjust the reverberation level via a ratio parameter and compensate for the average distance-gain attenuation by adjusting the value of the ratio parameter or adjusting the value of at least one parameter associated with a filter designed to adjust the said ratio in the output of the reverberator.

In some embodiments, the apparatus and methods comprise receiving bitstream information if average distance gain attenuation compensation is to be applied for an acoustic environment.

In some embodiments, the apparatus and methods comprise receiving bitstream information of the amount of average distance gain attenuation.

It is understood that MPEG-I Audio Phase 2 will normatively standardize the bitstream and the renderer processing. There will also be an encoder reference implementation, but it can be modified later on as long as the output bitstream follows the normative spec. This allows improving the codec quality also after the standard has been finalized with novel encoder implementations.

With respect to the embodiments described herein, the portions going to different parts of the MPEG-I standard can be as follows:
the normative bitstream can optionally contain the average distance gain attenuation for each acoustic environment, or an indicator whether average distance gain attenuation is to be calculated and compensated for by the renderer;
the normative renderer shall decode the bitstream to obtain scene and reverberator parameters, initialize a reverberator for rendering using the reverberator parameters, determine or obtain from bitstream the average late reverb distance gain attenuation for each acoustic environment, receive an input signal and source position, and render reverberated signal using the reverberator and the input signal while calculating source-listener distance dependent gain and compensating that with the average distance gain attenuation;

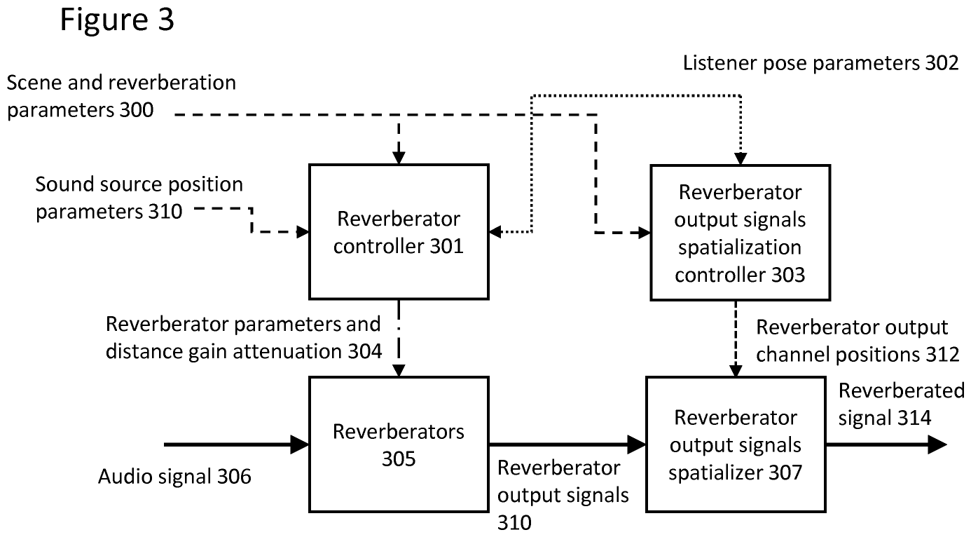

With respect to FIG. 3 is shown an example system of apparatus suitable for implementing some embodiments.

The input to the system of apparatus is scene and reverberator parameters 300, listener pose parameters 302 and audio signal 306. The system of apparatus generates as an output, a reverberated signal 314 (e.g. binauralized with head-related-transfer-function (HRTF) filtering for reproduction to headphones, or panned with Vector-Base Amplitude Panning (VBAP) for reproduction to loudspeakers).

In some embodiments the apparatus comprises a reverberator controller 301. The reverberator controller 301 is configured to obtain or receive the scene and reverberation parameters 300. In this example implementation the scene and reverberation parameters are in the form of a bitstream which contains enclosing room geometry and parameters describing the RT60 times and reverberant-to-direct ratio (RDR) for the enclosure (or Acoustic Environment).

The reverberator controller 301 is configured to obtain the bitstream, convert the encoded reverberation parameters into parameters for a reverberator (reverberator parameters), and pass the reverberator parameters to initialize at least one FDN reverberator to reproduce reverberation according to the reverberator parameters.

The reverberator controller 301 can furthermore be configured to receive listener pose parameters 302, in other words parameters which indicate the position and/or orientation of the listener within the virtual (or augmented) scene (or acoustic environment) and the sound source position parameters 310 (in other words parameters which indicate or assist to define sounds located within the acoustic environment).

In some embodiments the reverberator controller 301 is further configured to generate distance gain attenuation parameter values. The distance gain attenuation parameter values are an indicator of a reverberation level (in other words a desired source-listener distance dependent level or gain). This level or gain changes over time as the listener or source move in the scene with increasing source-listener distance leading to smaller gain values. In order to produce the level or gain information, the reverberator controller 301 is configured to employ the scene parameters from the scene and reverberation parameters 300, listener pose parameters 302 and any sound source position parameters 310 from which the controller can use to determine where the listener currently is in the virtual scene and what is the distance from the listener to the sound source.

The reverberator parameters and the distance gain attenuation values 304 can then be passed to the reverberator(s) 305.

In some embodiments the apparatus comprises a reverberator or reverberators 305. The reverberator(s) are configured to receive the reverberator parameters (and the distance gain attenuation values) 304 and the audio signal Sᵢₙ(t) (where t is time) 306. In some embodiments the reverberator(s) 305 are configured to reverberate the audio signal 306 based on the reverberator parameters (and distance gain attenuation values) 304.

The details of the reverberation processing are presented in further detail later.

The reverberators 305 in some embodiments output the resulting reverberator output signals S_{rev,r}(j, t) 310 (where j is the output audio channel index and r the reverberator index). There are several reverberators, each of which produce several output audio signals. These reverberator output signals 310 are input into a reverberator output signals spatializer 307.

Furthermore the apparatus comprises a reverberator output signals spatialization controller 303. The reverberator output signals spatialization controller 303 is configured to receive the scene and reverberation parameters 300 and the listener pose parameters 302 and generate reverberator output channel positions 312. The reverberator output channel positions 312 in some embodiments indicates cartesian coordinates which are to be used when rendering each of the signals in S_{rev,r}(j, t). In some other embodiments other representations (or other co-ordinate system) such as polar coordinates can be used. The output channel positions can be virtual loudspeaker positions (or positions in a space which are unrelated to an actual or physical loudspeaker but can be used to generate a suitable spatial audio signal format such as binaural audio signals), or actual loudspeaker positions (for example in multi-speaker systems such as 5.1, 7.2 channel systems).

In some embodiments the apparatus comprises a reverberator output signals spatializer 307. The reverberator output signals spatializer 307 is configured to obtain the reverberator output signals 310 and the reverberator output channel positions 312 and based on these produce an output signal suitable for reproduction via headphones or via loudspeakers. In some embodiments the reverberator output signals spatializer 307 is configured to render each reverberator output into a desired output format, such as binaural, and then sum the signals to produce the output reverberated signal 314. For binaural reproduction the reverberator output signals spatializer 307 can further use HRTF filtering to render the reverberator output signals 310 in their desired positions indicated by the reverberator output channel positions 312.

This reverberation in the reverberated signals 314 is therefore based on the scene and reverberation parameters 300 as was desired and further considers listener pose parameters 302 and sound source position parameters 310.

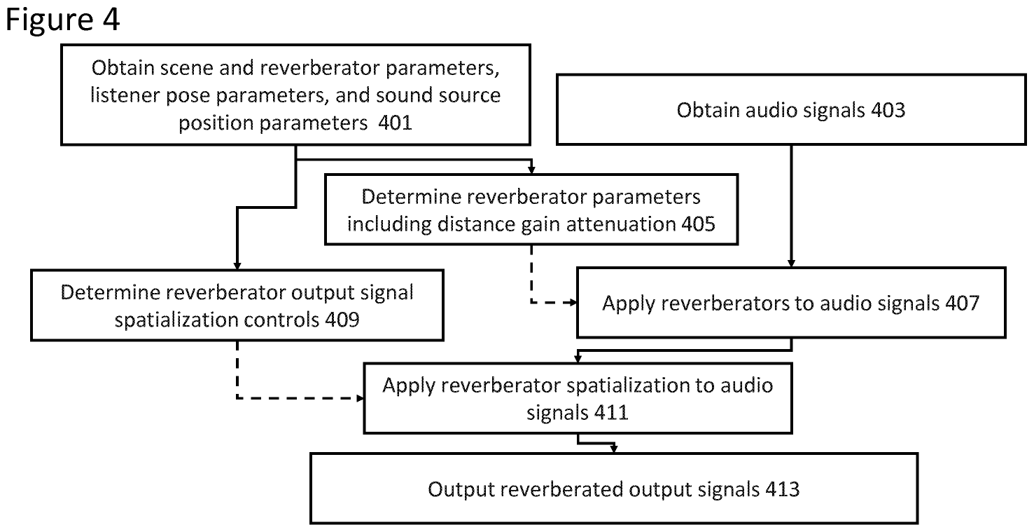

With respect to FIG. 4 is shown a flow diagram showing the operations of example apparatus shown in FIG. 3 according to some embodiments.

Thus, for example, the method may comprise obtaining scene and reverberator parameters and obtaining listener pose parameters (and sound source position parameters) is shown in FIG. 4 by step 401.

Furthermore the audio signals are obtained which is shown in FIG. 4 by step 403.

Then the reverberator controls are determined where the reverberator parameters including the distance gain attenuation parameter (based on obtained scene and reverberation parameters, listener pose parameters and sound source position parameters) is shown in FIG. 4 by step 405.

Then the reverberators controlled by the reverberator controls are applied to the audio signals as shown in FIG. 4 by step 407.

Furthermore the reverberator output signal spatialization controls are determined based on the obtaining scene and reverberator parameters and listener pose parameters as shown in FIG. 4 by step 409.

The reverberator spatialization based on the reverberator output signal spatialization controls can then be applied to the reverberated audio signals from the reverberators to generate output reverberated audio signals as shown in FIG. 4 by step 411.

Then the output reverberated audio signals are output as shown in FIG. 4 by step 413.

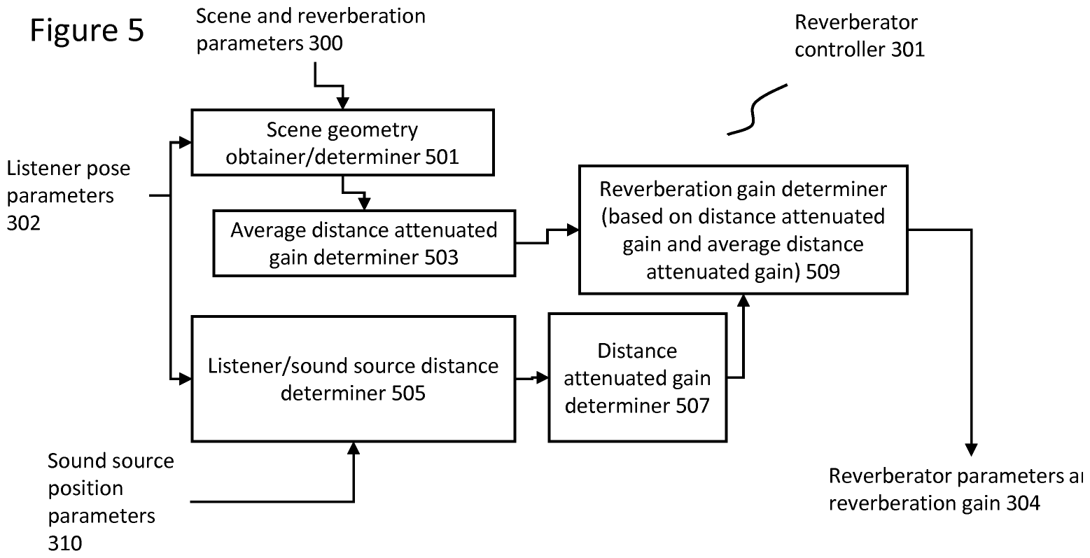

With respect to FIG. 5 there is shown in further detail an example reverberator controller 301. As discussed above the reverberator controller 301 is configured to provide reverberator parameters including reverberation gain parameters to the reverberator(s). The reverberator controller 301 is configured to receive scene and reverberation parameters which describe the reverberation characteristics in each acoustic environment (each acoustic environment contains at least one set of reverberation parameters). The reverberation controller 301 can be configured to decode the obtained reverberation parameters and convert the decoded parameters into reverberator parameters. In some embodiments the reverberation controller 301 can be configured to decode the obtained reverberation parameters into reverberator parameters which can then be provided to the reverberator(s). This is the case, for example, when a bitstream carries reverberator parameters produced by an encoder device.

The input to the apparatus can be configured to provide the desired RT60 times per specified frequencies k denoted as RT60(k) and DDR values DDR (k). An alternative representation for the DDR is RDR, or its logarithm logRDR (k). To be useful for reverberation, parameters for a reverberator need to be obtained based on these values, so that the reverberator 305 can then be used for reproducing reverberation.

In some embodiments the reverberation controller 301 comprises a scene geometry obtainer/determiner 501. The scene geometry obtainer/determiner 501 is configured to obtaining the scene and reverberation parameters 300 and listener pose parameters 302 and obtain or otherwise determine the scene geometry. The scene geometry can be represented with a bounding box which can enclose a virtual room (or correspond to the dimensions of a physical room provided in a listening space description file LSDF). The enclosure dimensions can then be employed or used. For example, a shoebox shaped room can be defined with dimensions xDim, yDim, zDim. If the room is not shaped as a shoebox then a shoebox (or cuboid) can be fit inside the room and the dimensions of the fitted shoebox can be utilized. Alternatively, in some embodiments, the average dimensions can be obtained as the two longest orthogonal dimensions along each of the cartesian axes in the non-shoebox shaped room, or other suitable method.

Such dimensions can also be obtained from a mesh if the bounding box is provided as a mesh. The dimensions can further be converted to modified dimensions of a virtual room or enclosure having the same volume as the input room or enclosure. For example, the ratios 1, 1.3, and 1.9 can be used for the converted virtual room dimensions. When the method is executed in the renderer then the enclosure vertices are obtained from the bitstream and the dimensions can be calculated, along each of the axes x, y, z, by the difference of the maximum and minimum value of the vertices.

In some embodiments the dimensions along the floor of the space are selected. Floor dimensions can be, in some embodiments, the Width and Depth of the room enclosing box. In some embodiments this can be defined as:

$$boundingBoxWidth = boundingBox [ 0 ] . high - boundingBox [ 0 ] . low ;$$

$$boundingBoxDepth = boundingBox [ 2 ] . high - boundingBox [ 2 ] . low ;$$

where low and high are the maximum coordinate values on an axis, and the cartesian axes x, y, and z have indices 0, 1, and 2, respectively. The term boundingBox is a data structure storing the values of the bounding box coordinates (its corners).

In some embodiments the reverberation controller 301 comprises an average distance attenuated gain determiner 503 configured to obtain the scene geometry and determine an estimate of the average distance of two points.

In an example embodiment, the average distance attenuated gain determiner uses an estimate of the average distance of two points (sound source and a listener) in the scene geometry to estimate the average distance gain attenuation. In an embodiment, the average distance between a source and a listener is estimated by calculating the average distance between two uniformly-distributed random points inside a rectangle having sides of length Lw and Lh. An example closed form expression to produce this value can be found at https://math.stackexchange.com/questions/208666/average-distance-between-random-points-in-a-rectangle.

In some embodiments the average distance (averDist) can be calculated by the following pseudocode:

$$Lw 2 = Lw ⋆ Lw$$

$$Lh 2 = Lh ⋆ Lh$$

$$d = sqrt ( Lw 2 + Lh 2 )$$

$$temp 1 = d * ( 3. f - Lw 2 / Lh 2 - Lh 2 / Lw 2 )$$

$$temp 2 = 5. f / 2 * ( Lh 2 / Lw * log ( ( L w + d ) / Lh ) + Lw 2 / Lh * log ( ( L h + d ) / Lw ) )$$

$$averDist = 1. f / 15 * ( Lw * Lw 2 / Lh 2 + Lh * Lh 2 / Lw 2 + temp 1 + temp 2 )$$

where sqrt denotes the square root and log the natural logarithm.

In some embodiments Lw=boundingBoxWidth and Lh=boundingBoxDepth.

In some embodiments if the space geometry does not exactly follow a rectangle for which the above closed form expression applies the space can be approximated with a rectangle and the above expression be used for the dimensions of the rectangle approximation of the scene floor dimensions.

The above method of using a closed form expression to obtain an estimate of the average source-listener distance is appropriate in scene geometries for which closed form approximations exist. The approximation expression is selected based on the geometry of the space in this case, so different geometries can use different expressions.

In some other embodiments, the average source-listener distance is estimated with alternative means to closed form geometric expressions. Other means are appropriate for geometries for which no closed form expressions exist. In some embodiments an alternative to the above is performing a sampling procedure to simulate possible source and listener positions in the scene geometry. This is applicable to arbitrary scene geometries. The steps in such embodiments can be as follows:

Initialize an average distance variable to zero

Divide the scene geometry into equivalent size cells such as rectangles for 2D approximation or cuboids for 3D approximation

Perform a sufficiently large number of sampling runs, where at each round:
source and listener each get a uniformly sampled position in the cells; and
calculate the distance between the sampled positions and sum into an average distance variable;

After the sampling runs have been completed, divide the average distance variable with the number of sampling runs.

This provides an estimate of the average distance between source and listener in the scene geometry.

In some embodiments the average distance attenuated gain determiner 503 is configured to determine or select whether to use 3D or 2D approximation of the space by determining whether 1) the listener can reach different heights in the geometry and 2) whether sound sources are located or can be located at different heights in the scene geometry. If either 1) or 2) are possible and the height between different source listener positions can be larger than a predetermined threshold, such as 3 meters, a 3D approximation can be more appropriate and the estimation performed relative to 3D space rather than 2D space.

In some embodiments the average source-listener distance is at least partly obtained based on metadata associated with the physical or virtual scene, where metadata relates to source positions or listener positions. If for example the scene metadata carries information on possible listener reachable areas then the possible listener positions in the above sampling procedure can be limited to such areas. If the scene description provides positions for one or more sound sources then the source positions can be limited to those positions in the sampling procedure.

The average distance estimation procedure can also be performed over time if sound sources have dynamically moving trajectories. In this case different average distances can be estimated for possible positions of the sound sources as they move along with their trajectories, and the average of the average distances over time can be used as the average distance.

In some embodiments the average distance is calculated for each sound source separately and a separate distance gain compensation value is used for each sound source.

It is noted that the distance gain compensation value can also be manually adjusted or input by a content creator. It can be entirely or partly based on scene geometry and source-listener distance in the scene geometry.

It is noted that the obtaining of the distance gain compensation value does not necessarily involve the obtaining of the average distance between a source and a listener in the scene geometry. An alternative means is to sample or calculate distance gain attenuation values at different source-listener position combinations in the scene and tabulate the distance gain attenuation values. Then an average such as a geometric mean or arithmetic mean of the distance gain attenuation values can be obtained as averageDistanceGain.

In some embodiments the reverberation controller 301 comprises an average distance attenuated gain determiner 503. The average distance attenuated gain determiner is configured to receive the average distance and generate a gain which is passed to the reverberation gain determiner 509. In some embodiments the reverberation controller 301 comprises a listener/sound source distance determiner 505. In these embodiments the listener/sound source distance determiner 505 is configured to use the listener pose parameters and the sound source position parameters to determine a distance between the sound source and listener pose parameters.

The listener/sound source distance determiner 505 is configured to pass this value to the distance attenuated gain determiner 507.

In some embodiments the reverberation controller 301 comprises a distance attenuated gain determiner 507 configured to obtain the distance value and generate a gain based on the distance which can be passed to the reverberation gain determiner 509.

In some embodiments the reverberation controller 301 comprises a reverberation gain determiner 509 configured to receive the gains from the average distance attenuated gain determiner and the distance attenuated gain determiner and generate the reverberation gain parameter.

In some embodiments the distance attenuated gain distanceGain to be applied to reverberator input is determined as follows in the current ISO/IEC 23090-4 MPEG-I Audio Phase 2 renderer. It is noted that the method is not limited to this way of calculating the distance attenuated gain and the invention is applicable to other ways of calculating the source-listener distance dependent gain. The Cartesian coordinates (x, y, z) of the sound source position are obtained. The Cartesian coordinates of the listener position (Ix, ly, Iz) are also obtained, and the distance d between the source and the listener is calculated as the Euclidean distance.

Limiting of the distance from getting too small can further be applied by taking the maximum of d and a predefined minimumDistance. minimumDistance can be set to one meter. Such limiting is useful from preventing the gain g from getting too large when the listener is close to a sound source.

The following procedure can be used to calculate the distance attenuated gain:

distanceGain = calculateDistanceGain(distance) {
d = max(minimumDistance, distance)
dbGain = distanceGainDbFactor * log10(refDistance / d)
distanceGain = pow(10.0, dbGain / 20.0)
}

Here, distanceGainDbFactor is calculated as

$$distanceGainDbFactor = distanceGainDropDb / log 10 ( 2. )$$

In an embodiment, distanceGainDropDb can have a value such as 1.5 dB.

refDistance is a reference distance in meters set by the content creator as defined by the MPEG-I Encoder Input Format and corresponds to the distance at which the calculated attenuation for this input signal is OdB.

Based on the source-listener distance, the distance attenuated gain for the sound source can thus be obtained in the distance attenuated gain determiner 507 by

distanceGain=calculateDistanceGain (d)

where d is the current source-listener distance.

The average distance attenuated gain averageDistanceGain can then be determined within the average distance attenuated gain determiner 503 so that it can be compensated for.

averageDistanceGain=calculateDistanceGain (averDist) where averDist is the average source-listener distance determined using some of the embodiments described.

The reverberation gain g to be applied to reverberator input can then be determined as

g=distanceGain/averageDistanceGain

In some embodiments the average distance gain can be calculated during renderer initialization and stored as a normalization factor

$$averageDistanceGainCompensation = 1 / averageDistanceGain$$

so that the gain compensation does not need to be calculated again during the renderer running.

Alternatively to the above, the compensation is obtained with the average distance, so that average distance between source and the listener is subtracted from the current source-listener distance before calculating the distance gain.

The input signal after the gain g has been applied is fed into a digital reverberator. In a preferred implementation, the digital reverberator is a feedback-delay-network (FDN) reverberator. Other suitable reverberator realizations can be used as well.

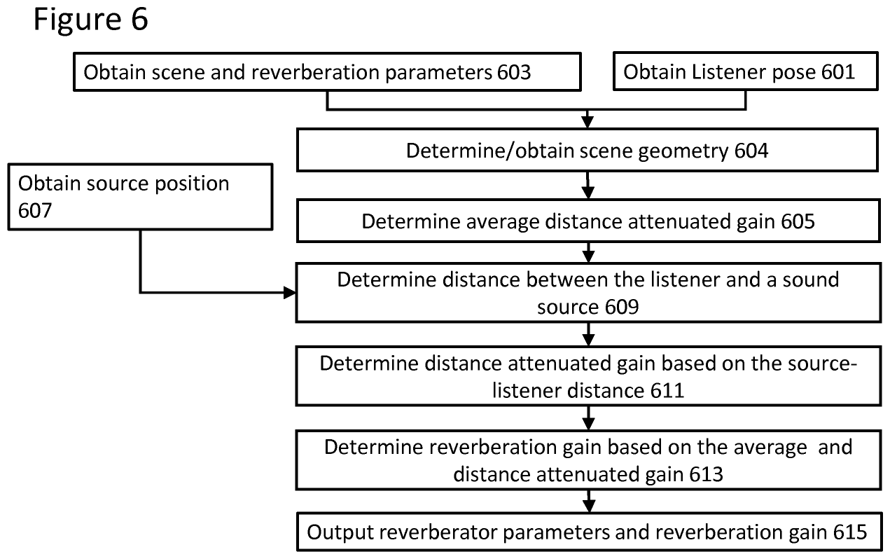

With respect to FIG. 6 is shown the flow diagram of the operations of the example reverberator controller 301 shown in FIG. 5 according to some embodiments.

The operation of obtaining listener pose is shown in FIG. 6 by step 601.

Thus the operation of obtaining scene and reverberation parameters is shown in FIG. 6 by step 603.

Then the scene geometry is obtained or determined as shown in FIG. 6 by step 604.

Having determined the scene geometry the average distance attenuated gain is determined as shown in FIG. 6 by step 605.

The source position is then obtained as shown in FIG. 6 by step 607.

The determination of the distance between the listener and a sound source is shown in FIG. 6 by step 609.

Then the distance attenuated gain based on the source-listener distance is generated as shown in FIG. 6 by step 611.

The determination of the reverberation gain based on the average and distance attenuated gains is shown in FIG. 6 by step 613.

The reverberation gain is then output as shown in FIG. 6 by step 615.

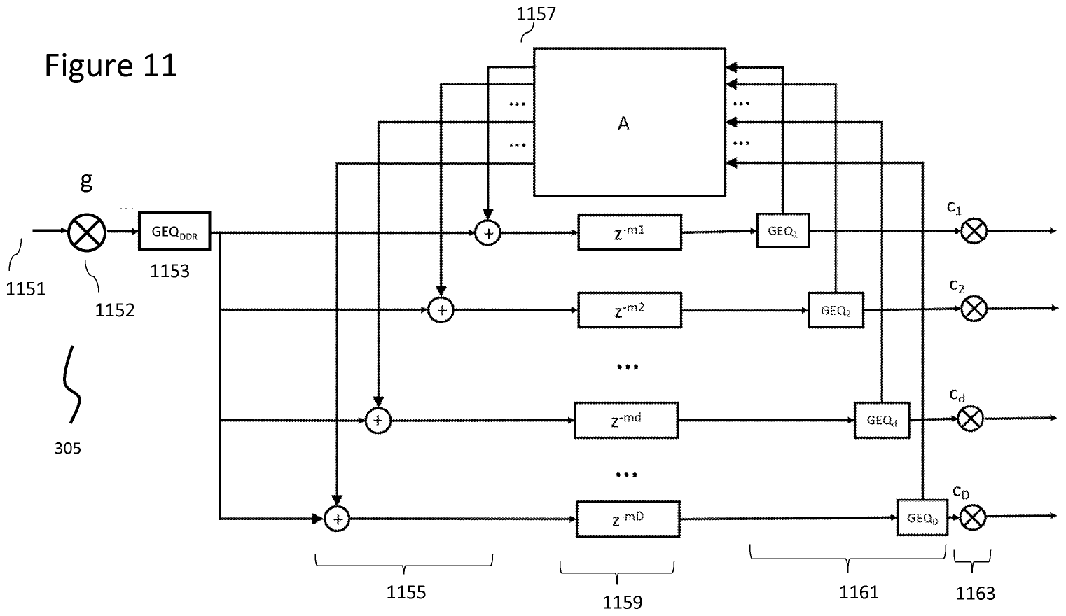

The generation of reverberator parameters are discussed herein in further detail and with respect to an example reverberator 305 as shown schematically in FIG. 11 as a FDN (graphic equalizer filter) configuration. The reverberator 305 which is enabled or configured to produce reverberation whose characteristics match the room parameters. There may be several of such reverberators, each parameterized based on the reverberation characteristics of an acoustic environment. An example reverberator implementation comprises a feedback delay network (FDN) reverberator and DDR control filter which enables reproducing reverberation having desired frequency dependent RT60 times and levels. The room parameters are used to adjust the FDN reverberator parameters such that it produces the desired RT60 times and levels. An example of a level parameter can the direct-to-diffuse-ratio (DDR) (or the diffuse-to-total energy ratio as used in MPEG-I). The output from the FDN reverberator are the reverberated audio signals which for binaural headphone reproduction are then reproduced into two output signals and for loudspeaker output means typically more than two output audio signals. Reproducing several outputs such as 15 FDN delay line outputs to binaural output can be done, for example, via HRTF filtering.

FIG. 11 shows an example FDN reverberator in further detail and which can be used to produce D uncorrelated output audio signals. In this example each output signal can be rendered at a certain spatial position around the listener for an enveloping reverb perception.

The FDN reverberator 305 in some embodiments comprises an input gain amplifier 1152 configured to receive the input 1151 and apply a gain g and output the gain applied input to a DDR energy ratio control filter (GEQDDR) 1153.

The example FDN reverberator 305 further comprises a DDR energy ratio control filter (GEQDDR) 1153 which applies a filter configured by the DDR energy ratio control filter coefficients GEQ_{ddr}. Furthermore the reverberator is configured such that the reverberation parameters are processed to generate coefficients GEQ_{d}(GEQ₁, GEQ₂, . . . . GEQ_{D}) of each attenuation filter 1161, feedback matrix 1157 coefficients A, lengths m_{d}(m₁, m₂, . . . m_{D}) for D delay lines 1159. The example FDN reverberator 305 thus shows a D-channel output, by providing the output from each FDN delay line as a separate output.

In some embodiments each attenuation filter GEQ_{d} 1161 is implemented as a graphic EQ filter using M biquad IIR band filters. With octave bands M=10, thus, the parameters of each graphic EQ comprise the feedforward and feedback coefficients for biquad IIR filters, the gains for biquad band filters, and the overall gain.

The reverberator uses a network of delays 1159, feedback elements (shown as attenuation filters 1161, feedback matrix 1157 and combiners 1155 and output gain 1163) to generate a very dense impulse response for the late part. Input samples 1751 are input to the reverberator to produce the reverberation audio signal component which can then be output.

The FDN reverberator comprises multiple recirculating delay lines. The unitary matrix A 1157 is used to control the recirculation in the network. Attenuation filters 1161 which may be implemented in some embodiments as graphic EQ filters implemented as cascades of second-order-section IIR filters can facilitate controlling the energy decay rate at different frequencies. The filters 1161 are designed such that they attenuate the desired amount in decibels at each pulse pass through the delay line and such that the desired RT60 time is obtained.

For the FDN reverberator the parameters contain the coefficients of each attenuation filter GEQ_{d}, feedback matrix coefficients A, and lengths ma for D delay lines. In this invention, each attenuation filter GEQ_{d} is a graphic EQ filter using M biquad IIR band filters.

With octave bands M=10, thus, the parameters of each graphic EQ comprise the feedforward b and feedback a coefficients for 10 biquad IIR filters, the gains for biquad band filters, and the overall gain.

The number of delay lines D can be adjusted depending on quality requirements and the desired tradeoff between reverberation quality and computational complexity. In an embodiment, an efficient implementation with D=15 delay lines is used. This makes it possible to define the feedback matrix coefficients A as proposed by Rocchesso in Maximally Diffusive Yet Efficient Feedback Delay Networks for Artificial Reverberation, IEEE Signal Processing Letters, Vol. 4. No. 9, September 1997, in terms of a Galois sequence facilitating efficient implementation.

A length ma for the delay line d can be determined based on virtual room dimensions. Here, we use the dimensions of the enclosure. For example, a shoebox shaped room can be defined with dimensions xDim, yDim, zDim. If the room is not shaped as a shoebox (or cuboid) then a shoebox can be fit inside the room and the dimensions of the fitted shoebox can be utilized for the delay line lengths. Alternatively, the dimensions can be obtained as three longest dimensions in the non-shoebox shaped room, or other suitable method. Such dimensions can also be obtained from a mesh if the bounding box is provided as a mesh. The dimensions can further be converted to modified dimensions of a virtual room or enclosure having the same volume as the input room or enclosure. For example, the ratios 1, 1.3, and 1.9 can be used for the converted virtual room dimensions. When the method is executed in the renderer then the enclosure vertices are obtained from the bitstream and the dimensions can be calculated, along each of the axes x, y, z, by the difference of the maximum and minimum value of the vertices.

The delays can in some embodiments be set proportionally to standing wave resonance frequencies in the virtual room or physical room. The delay line lengths ma can further be made mutually prime.

The attenuation filter coefficients in the delay lines can furthermore be adjusted so that a desired amount in decibels of attenuation happens at each signal recirculation through the delay line so that the desired RT60(k) time is obtained. This is done in a frequency specific manner to ensure the appropriate rate of decay of signal energy at specified frequencies k.

For a frequency k, the desired attenuation per signal sample is calculated as attenuationPerSample (k)=−60/(samplingRate*rt60(k)). The attenuation in decibels for a delay line of length ma is then attenuationDb (k)=m_{d}*attenuationPerSample (k).

Furthermore when reverberator parameters are derived in the encoder (reverb_method_type==1), the attenuation filters are designed as cascade graphic equalizer filters as described in V. Välimäki and J. Liski, “Accurate cascade graphic equalizer,” IEEE Signal Process. Lett., vol. 24, no. 2, pp. 176-180, February 2017, for each delay line. The design procedure outlined takes as input a set of command gains at octave bands. There are also methods for a similar graphic EQ structure which can support third octave bands, increasing the number of biquad filters to 31 and providing better match for detailed target responses such as indicated in Third-Octave and Bark Graphic-Equalizer Design with Symmetric Band Filters, https://www.mdpi.com/2076-3417/10/4/1222/pdf.

When reverberator parameters are derived in the renderer (reverb_method_type==2 or reverb_method_type==3 or an AR scene), a neurally controlled graphic equalizer design such as described in Välimäki, Rämö, “Neurally Controlled Graphic Equalizer”, IEEE/ACM TRANSACTIONS ON AUDIO, SPEECH, AND LANGUAGE PROCESSING, VOL. 27, NO. 12, December 2019 can be used. Furthermore in some embodiments if the method designs third octave graphic EQ then the method of Third-Octave and Bark Graphic-Equalizer Design with Symmetric Band Filters, https://www.mdpi.com/2076-3417/10/4/1222/pdf can be employed.

Reverberation ratio parameters can refer to the diffuse-to-total energy ratio (DDR) or reverberant-to-direct ratio (RDR) or other equivalent representation. The ratio parameters can be equivalently represented on a linear scale or logarithmic scale.

A filter is designed in the step such that, when the filter is applied to the input data of the FDN reverberator, the output reverberation is configured to have the desired energy ratio defined by the DDR (k). The input to the design procedure can in some embodiments be the DDR values DDR (k).

When receiving linear DDR values DDR (b), the values can be converted to linear RDR values as

$$R D R ( b ) = DDR ( b ) * {10}^{( 41 / 10 )}$$

When receiving logarithmic RDR values logRDR (b), the values can be converted to linear RDR values as

$$R D R ( b ) = 1 {0}^{( logRD R ( b ) / 10 )}$$

The GEQDDR matches the reverberator spectrum energy to the target spectrum energy. In order to do this, an estimate of the RDR of the reverberator output and the target RDR is obtained. The RDR of the reverberator output can be obtained by rendering a unit impulse through the reverberator using the first reverberator parameters and measuring the energy of the reverberator output and energy of the unit impulse and calculating the ratio of these energies.

In some embodiments a unity impulse input is generated where the first sample value is 1 and the length of the zero tail is long enough. In practice, we have adjusted the length of the zero tail to equal max (RT60(b)) plus the t_{predelay} in samples. The monophonic output of the reverberator is of interest so the filter is configured to sum over the delay lines j to obtain the reverberator output sᵣₑᵥ(t) as a function of time t.

A long FFT (of length NFFT) is calculated over Sᵣₑᵥ (t) and its absolute value is obtained as

FFA(kk)=abs(FFT(Sᵣₑᵥ(t))

Here, kk are the FFT bin indices. The positive half spectral energy density is obtained as

$$S ( kk ) = 1 / NFFT * {FFA ( kk )}^{2}$$

where the energy from the negative frequency indices kk is added into the corresponding positive frequency indices kk.

The energy of a unit impulse can be calculated or obtained analytically and can be denoted as Su (kk).

Band energies are calculated of both the positive half spectral energy density of the reverberator S (kk) and the positive half spectral energy density of the unit impulse Su (kk). Band energies can be calculated as

$$S ( b ) = {\sum }_{k k = {b}_{l o w}}^{{b}_{high}} S ( k k )$$

where b_{low} and b_{high} are the lowest and highest bin index belonging to band b, respectively. The band bin indices can be obtained by comparing the frequencies of the bins to the lower and upper frequencies of each band.

The reproduced RDRᵣₑᵥ(b) of the reverberator output at the frequency band b is obtained as

$$R D {R}_{r e v} ( b ) = S ( b ) / Su ( b )$$

The target linear magnitude response for GEQDDR can be obtained as

$$ddrFilterTargetRespons e ( b ) = s q r t ( R D R ( b ) ) / sqr t ( R D {R}_{r e v} ( b ) )$$

where RDR (b) is the linear target RDR value mapped to frequency band b.

GontrolGain (b)=20*log 10 (ddrFilterTargetResponse (b)) is input as the target response for the graphic equalizer design routine in Valimäki, Rämö, “Neurally Controlled Graphic Equalizer”, IEEE/ACM TRANSACTIONS ON AUDIO, SPEECH, AND LANGUAGE PROCESSING, VOL. 27, NO. 12, December 2019.

In some embodiments, the average distance gain compensation is calculated and included into the parameters of the DDR filter. In this case, the average distance gain compensation in decibels can be calculated as

$$averageDistanceGainCompensationDb = 20 * log 10 ( averageDistanceGainCompensation )$$

And a modified DDR filter target response can be obtained as

$$ControlGain ( b ) = 10 {log}_{10} ( R D R ( k ) ) - 10 {log}_{10} ( R D {R}_{r e v} ( b ) ) + averageDistanceGainCompensationDb$$

The above compensation can be calculated in the renderer when rendering is done for physical acoustic environments based on the listening space description. In this case the scene geometry which is required for the calculation of the average distance gain is available only at the renderer.

The above compensation can be calculated in the encoder when rendering is done for virtual acoustic environments. In this case, bitstream signalling can be used to indicate to the renderer if average distance gain compensation has been included in the DDR filter so that the renderer does not reapply distance gain compensation. Such signalling can be provided e.g by setting applyAverageDistanceGainCompensation to 0.

Alternatively the average distance gain compensation value as linear gain or in decibels can be signalled in the bitstream.

The first reverberator parameters and the parameters of the reverberator DDR control filter GEQDDR together form the complete final reverberator parameters.

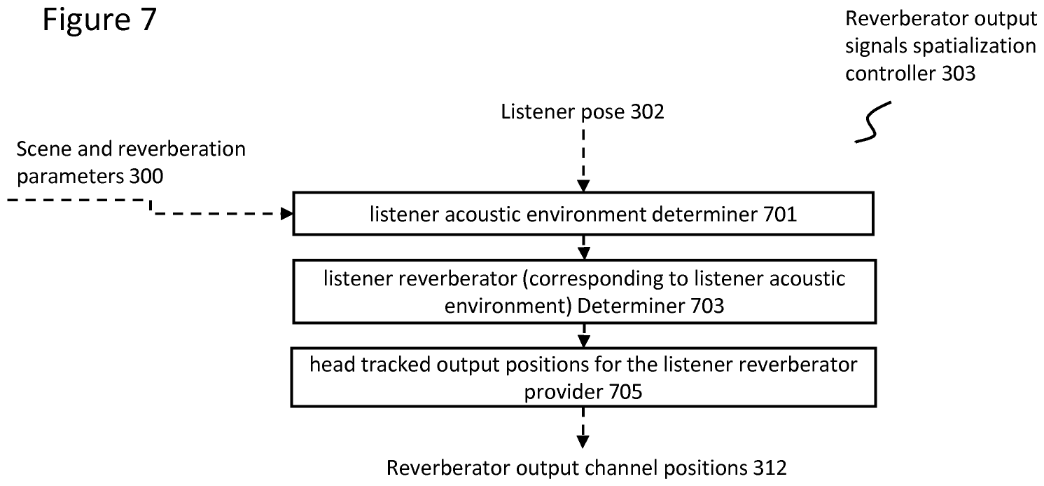

With respect to FIG. 7 there is shown in further detail the reverberator output signals spatialization controller 303 as shown in FIG. 3.

The reverberator output signals spatialization controller 303 is configured to receive the scene and reverberator parameters 300 and listener pose parameters 302. The reverberator output signals spatialization controller 303 is configured to use the listener pose parameters 302 and scene and reverberator parameters 300 to determine the acoustic environment where the listener currently is and provide that reverberator output channels such positions which surround the listener. This means that the reverberation when inside an acoustic enclosure, caused by that acoustic enclosure, is rendered as a diffuse signal enveloping the listener.

In some embodiments the reverberator output signals spatialization controller 303 comprises a listener acoustic environment determiner 701 configured to obtain the scene and reverberator parameters 300 and listener pose parameters 302 and determine the listener acoustic environment.

In some embodiments the reverberator output signals spatialization controller 303 comprises a listener reverberator corresponding to listener acoustic environment determiner 703 which is further configured to determine listener reverberator corresponding to listener acoustic environment information.

In some embodiments the reverberator output signals spatialization controller 303 comprises a head tracked output positions for the listener reverberator provider 705 configured to provide or determine the head tracked output positions for the listener and generate the output channel position 312. The output of the reverberator output signals spatialization controller 303 is thus the reverberator output channel positions 312.

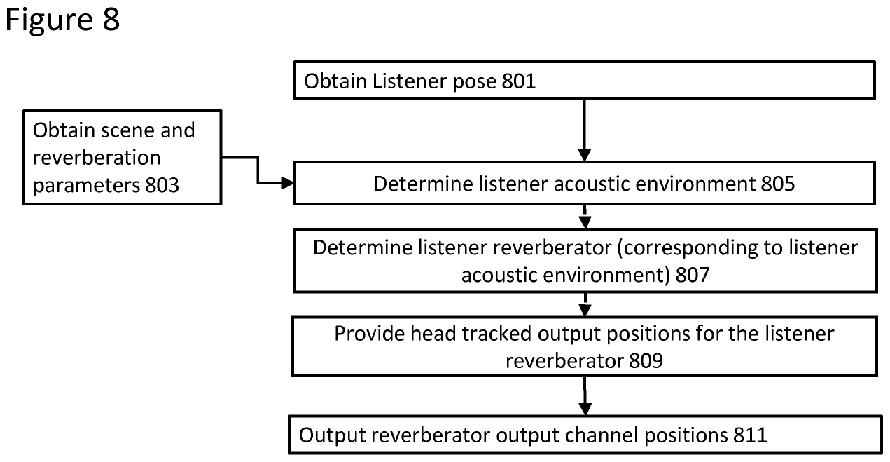

With respect to FIG. 8 is shown the operations of an example reverberator output signals spatialization controller 303 according to some embodiments.

Thus for example is shown obtaining scene and reverberator parameters as shown in FIG. 8 by step 803 and obtaining listener pose parameters as shown in FIG. 8 by step 801.

Then the method comprises determining listener acoustic environment as shown in FIG. 8 by step 805.

Having determined this then determine listener reverberator corresponding to listener acoustic environment as shown in FIG. 8 by step 807.

Further the method comprises providing head tracked output positions for the listener reverberator as shown in FIG. 8 by step 809.

Then outputting reverberator output channel positions as shown in FIG. 8 by step 811.

In some embodiments, the reverberator corresponding to the acoustic environment where the user currently is, is rendered by the reverberator output signals spatializer 307 as an immersive audio signal surrounding the user. That is, the signals in S_{rev,r}(j, t) corresponding to the listener environment are rendered as point sources surrounding the listener.

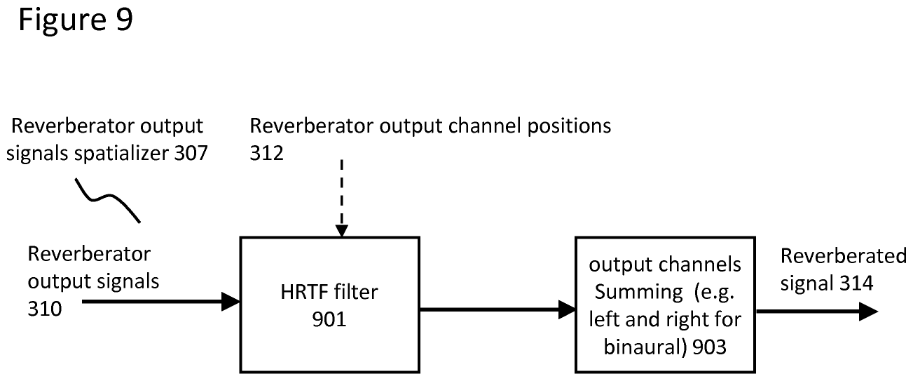

With respect to FIG. 9 there is shown in further detail the reverberator output signals spatializer 307. The reverberator output signals spatializer 307 is configured to receive the positions 312 from the reverberator output signals spatialization controller 303. Additionally is received the reverberator output signals 310 from the reverberators 305.

In some embodiments the reverberator output signals spatializer comprises a head-related transfer function (HRTF) filter 901 which is configured to render each reverberator output into a desired output format (such as binaural).

Furthermore in some embodiments the reverberator output signals spatializer comprises a output channels combiner 903 which is configured to combine (or sum) the signals to produce the output reverberated signal 314.

Thus for example for binaural reproduction the reverberator output signals spatializer 307 can use HRTF filtering to render the reverberator output signals in their desired positions indicated by reverberator output channel positions.

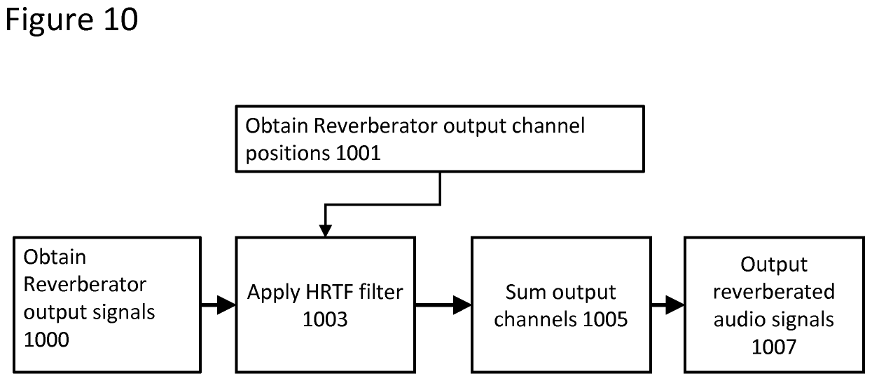

With respect to FIG. 10 is shown a flow diagram showing the operations of the reverberator output signals spatializer according to some embodiments.

Thus the method can comprise obtaining reverberator output signals as shown in FIG. 10 by step 1000 and obtaining reverberator output channel positions as shown in FIG. 10 by step 1001.

Then the method may comprise applying a HRTF filter configured by the reverberator output channel positions to the reverberator output signals as shown in FIG. 10 by step 1003.

The method may then comprise summing or combining the output channels as shown in FIG. 10 by step 1005.

Then the reverberated audio signals can be output as shown in FIG. 10 by step 1007.

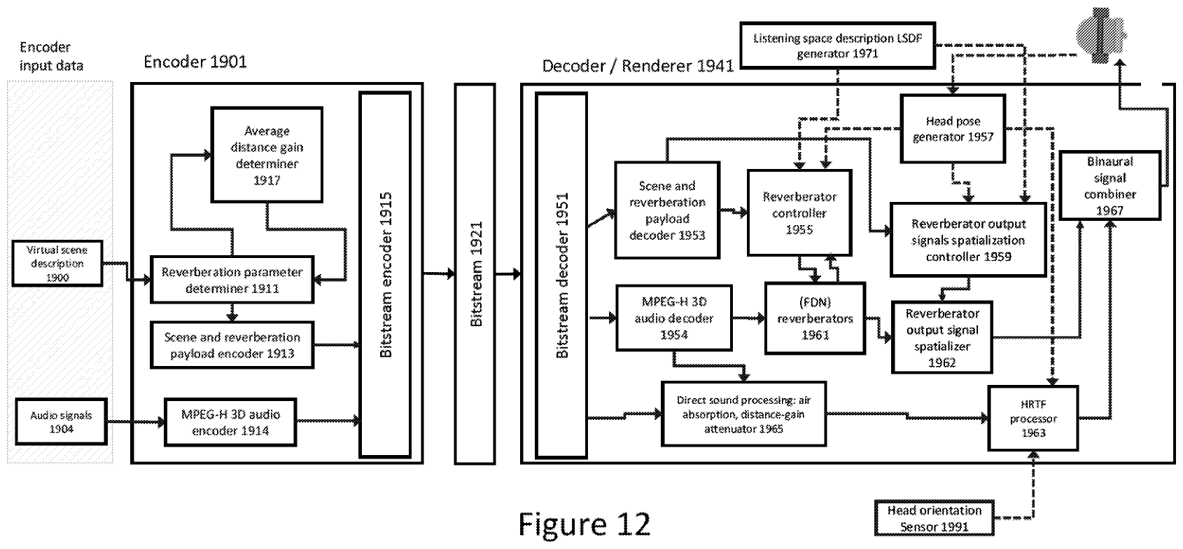

FIG. 12 shows schematically an example system where the embodiments are implemented in an encoder device 1901 which performs part of the functionality; writes data into a bitstream 1921 and transmits that for a renderer device 1941, which decodes the bitstream, performs reverberator processing according to the embodiments and outputs audio for headphone listening.

The encoder side 1901 of FIG. 12 can be performed on content creator computers and/or network server computers. The output of the encoder is the bitstream 1921 which is made available for downloading or streaming. The decoder/renderer 1941 functionality runs on end-user-device, which can be a mobile device, personal computer, sound bar, tablet computer, car media system, home HiFi or theatre system, head mounted display for AR or VR, smart watch, or any suitable system for audio consumption.

The encoder 1901 is configured to receive the virtual scene description 1900 and the audio signals 1904. The virtual scene description 1900 can be provided in the MPEG-I Encoder Input Format (EIF) or in other suitable format. Generally, the virtual scene description contains an acoustically relevant description of the contents of the virtual scene, and contains, for example, the scene geometry as a mesh, acoustic materials, acoustic environments with reverberation parameters, positions of sound sources, and other audio element related parameters such as whether reverberation is to be rendered for an audio element or not. The encoder 1901 in some embodiments comprises a reverberation parameter determiner 1911 configured to receive the virtual scene description 1900 and configured to obtain the reverberation parameters. The reverberation parameters can in an embodiment be obtained from the RT60, DDR, predelay, and region/enclosure parameters of acoustic environments.

The encoder 1901 furthermore in some embodiments comprises an average distance gain determiner 1917 configured to implement the average gain determination operations as described above and thus modify the reverberator parameters as indicated above also.

The encoder 1901 furthermore in some embodiments comprises a reverberation payload encoder 1913 configured to obtain the determined reverberation parameters and the reverberation ratio handling parameters and generate reverberation parameters.

The encoder 1901 on FIG. 12 can be executed on content creator computers and/or network server computers. The output of the encoder is the bitstream which is made available for downloading or streaming. It can reside on a content delivery network (CDN) for example. The decoder/renderer 1941 functionality in some embodiments runs on an end-user-device, which can be a mobile device, personal computer, sound bar, tablet computer, car media system, home HiFi or theatre system, head mounted display for AR or VR, smart watch, or any suitable system for audio consumption.

In the embodiments described herein the scene and reverberation parameters are encoded into a bitstream payload referred as a reverberation payload (generated by the reverberation payload encoder 1913).

Deriving reverberator parameters based on reverberation parameters can be implemented in some embodiments as described in the obtain parameters for at least one graphic EQ filter for a reverberator using the control gain data and obtain other parameters for a reverberator as indicated above.

The encoder 1901 further comprises a MPEG-H 3D audio encoder 1914 configured to obtain the audio signals 1904 and MPEG-H encode them and pass them to a bitstream encoder 1915.

The encoder 1901 furthermore in some embodiments comprises a bitstream encoder 1915 which is configured to receive the output of the scene and reverberation payload encoder 1913 and the encoded audio signals from the MPEG-H encoder 1914 and generate the bitstream 1921 which can be passed to the bitstream decoder 1941. The bitstream 1921 in some embodiments can be streamed to end-user devices or made available for download or stored.

The decoder 1941 in some embodiments comprises a bitstream decoder 1951 configured to decode the bitstream.

The decoder 1941 further can comprise a reverberation payload decoder 1953 configured to obtain the encoded reverberation parameters and decode these in an opposite or inverse operation to the reverberation payload encoder 1913.

The listening space description LSDF generator 1971 is configured to generate and pass the LSDF information to the reverberator controller 1955 and the reverberator output signals spatialization controller 1959.

Furthermore the head pose generator 1957 receives information from a head mounted device or similar and generates head pose information or parameters which can be passed to the reverberator controller 1955, the reverberator output signals spatialization controller 1959 and HRTF processor 1963.

The decoder 1941, in some embodiments, comprises a reverberator controller 1955 which also receives the output of the scene and reverberation payload decoder 1953 and generates the reverberation parameters for configuring the reverberators and passes this to the reverberators 1961.

In some embodiments the decoder 1941 comprises a reverberator output signals spatialization controller 1959 configured to configured the reverberator output signals spatializer 1962.

The decoder 1941 comprise MPEG-H 3D audio decoder 1954 which is configured to decode the audio signals and pass them to the (FDN) reverberators 1961 and direct sound processing 1955.

The decoder 1941 furthermore comprises (FDN) reverberators 1961 configured by the reverberator controller 1955 and configured to implement a suitable reverberation of the audio signals. In some embodiments obtaining and/or applying source-listener distance based gain while compensating for the average source-listener distance based gain attenuation can be configured by the reverberation controller 1955.

The output of the (FDN) reverberators 1961 is configured to output to a reverberator output signal spatializer 1962.

In some embodiments the decoder 1941 comprises a reverberator output signal spatializer 1962 configured to apply the spatialization and output to the binaural combiner 1967.

Additionally the decoder/renderer 1941 comprises a direct sound processor 1965 which is configured to receive the decoded audio signals and configured to implement any direct sound processing such as air absorption and distance-gain attenuation and which can be passed to a HRTF processor 1963 which with the head orientation determination (from a suitable sensor 1991) can generate the direct sound component which with the reverberant component from the HRTF processor 1963 is passed to a binaural signal combiner 1967. The binaural signal combiner 1967 is configured to combine the direct and reverberant parts to generate a suitable output (for example for headphone reproduction).

Furthermore in some embodiments the decoder comprises a head orientation determiner 1991 which passes the head orientation information to the HRTF processor 1963.

Although not shown, there can be various other audio processing methods applied such as early reflection rendering combined with the proposed methods.

As indicated earlier MPEG-I Audio Phase 2 will normatively standardize the bitstream and the renderer processing. There will also be an encoder reference implementation, but it can be modified later on as long as the output bitstream follows the normative specification. This allows improving the codec quality also after the standard has been finalized with novel encoder implementations.

The portions going to different parts of the MPEG-I standard can be:
Encoder reference implementation will contain
   Deriving the reverberator parameters for each of the acoustic environments based on their RT60 and DDR
   Obtaining scene parameters from the encoder input and writing them into the bitstream.
   Calculating the average distance gain compensation and either including that into the DDR filter parameters or providing the compensation factor in the bitstream.
   Writing a bitstream description containing the (optional) reverberator parameters and scene parameters. If there is at least one virtual enclosure with reverberation parameter in the Virtual scene description, then there will be parameters for the corresponding reverberator written into the Reverb payload.
The normative bitstream shall contain (optional) reverberator parameters with the average distance gain attenuation information described using the syntax described here. The bitstream shall be streamed to end-user devices or made available for download or stored.
The normative renderer shall decode the bitstream to obtain the scene and reverberator parameters, and perform the reverberation rendering taking into account distance gain attenuation when needed as described in this invention.
   For VR rendering, reverberator and scene parameters are derived in the encoder and sent in the bitstream.
   For AR rendering, reverberator parameters and scene are derived in the renderer based on a listening space description format (LSDF) file or corresponding representation.
The complete normative renderer will also obtain other parameters from the bitstream related to room acoustics and sound source properties, and use them to render the direct sound, early reflection, diffraction, sound source spatial extent or width, and other acoustic effects in addition to diffuse late reverberation. The concept as discussed in the embodiments presented here focuses on the rendering of the diffuse late reverberation part and in particular how to enable second order reverberation.

In some embodiments the reverberation parameters mapped into digital reverberator parameters with DDR control filter GEQDDR parameters can be described in the following bitstream definition.

```
reverbPayloadStruct( ) {
  unsigned int(2) numberOfSpatialPositions;
  unsigned int(8) numberOfAcousticEnvironments;
  for(int i=0;i<numberOfSpatialPositions;i++) {
    signed int(32) azimuth;
    signed int(32) elevation;
  }
  for(int i=0; i<numberOfAcousticEnvironments;i++) {
      unsigned int(16) environmentsId;
      filterParamsStruct( );
      unsigned int(1)
applyAverageDistanceGainCompensation;
      for(int j=0;j<numberOfSpatialPositions;j++) {
      unsigned int(32) delayLineLength;
      filterParamsStruct( );
      }
  }
}
```

Semantics of reverbPayloadStruct ( ) numberOfSpatialPositions defines the number of output delay line positions for the late reverb payload. This value is defined using an index which corresponds to a specific number of delay lines. The value of the bit string ‘0b00’ signals the renderer to a value of 15 spatial orientations for delay lines. The other three values ‘0b01’, ‘0b10’ and ‘0b11’ are reserved.
azimuth defines azimuth of the delay line with respect to the listener.
The range is between-180 to 180 degrees. elevation defines the elevation of the delay line with respect to the listener. The range is between-90 to 90 degrees. numberOfAcousticEnvironments defines the number of acoustic environments in the audio scene. The reverbPayloadStruct ( ) carries information regarding the one or more acoustic environments which are present in the audio scene at that time. An acoustic environment has certain “Reverberation parameters” such as RT60 times which are used to obtain FDN reverb parameters.
environment Id This value defines the unique identifier of the acoustic environment.
delayLineLength defines the length in units of samples for the graphic equalizer (GEQ) filter used for configuration of the delay line attenuation filter. The lengths of different delay lines corresponding to the same acoustic environment are mutually prime.
filterParamsStruct ( ) this structure describes the graphic equalizer cascade filter to configure the attenuation filter for the delay lines. The same structure is also used subsequently to configure the filter for diffuse-to-direct reverberation ratio GEQDDR. The details of this structure are described in the next table.

```
aligned(8) filterParamsStruct( ) {
  SOSLength;
  If(SOSLength>0) {
    for (i=0;i<SOSLength;i++) {
      signed int(32) b1;
    }
    for (i=0;i<SOSLength;i++) {
      signed int(32) b2;
    }
    for (i=0;i<SOSLength;i++) {
      signed int(32) a1;
    }
    for (i=0;i<SOSLength;i++) {
      signed int(32) a2;
    }
  signed int(32) globalGain;
  signed int(32) levelDb;
  }
}
```

Semantics of filterParamsStruct ( )
SOSLength is the length of the each of the second order section filter coefficients.
b1, b2, a1, a2 The filter is configured with coefficients b1, b2, a1 and a2. These are the feedforward and feedback IIR filter coefficients of the second-order section IIR filters.
globalGain specifies the gain factor in decibels for the GEQ. levelDB specifies a sound level offset for each of the delay lines in decibels.
All filterParamsStruct ( ) get deserialized into a GEQ object in the renderer.
Semantics for handling distance gain attenuation compensation parameters
applyAverageDistanceGainCompensation For value equal to 0, the renderer shall not calculate average distance gain compensation for the acoustic enclosure or apply the average distance gain compensation. This can be defined by the content creator to omit distance gain compensation entirely, or to signal that the DDR filter parameters already contain the applied distance gain compensation. For value equal to 1, the renderer shall compensate for average distance compensation as described earlier.
Semantics for explicit distance gain compensation value signalling

```
reverbPayloadStruct( ) {
  unsigned int(2) numberOfSpatialPositions;
  unsigned int(8) numberOfAcousticEnvironments;
  for(int i=0;i<numberOfSpatialPositions;i++) {
    signed int(32) azimuth;
    signed int(32) elevation;
  }
  for(int i=0;i<numberOfAcousticEnvironments;i++) {
    unsigned int(16) environmentsId;
    filterParamsStruct( );
    signed int(32) averageDistanceGainCompensationDb;
    for(int j=0;j<numberOfSpatialPositions;j++) {
      unsigned int(32) delayLineLength;
      filterParamsStruct( );
    }
  }
}
```

averageDistanceGainCompensationDb Provides the average distance gain compensation value for this acoustic environment in decibels. The renderer can apply this as a linear averave distance gain compensation factor by obtaining

$$averageDistanceGainCompensation = pow ( 10 , averageDistanceGainCompensationDb / 20 ) .$$

The renderer can alternatively add this into a suitable decibel gain value such as the DDR filter target response of the reverberator of this acoustic environment in case the DDR filter is designed in the renderer.

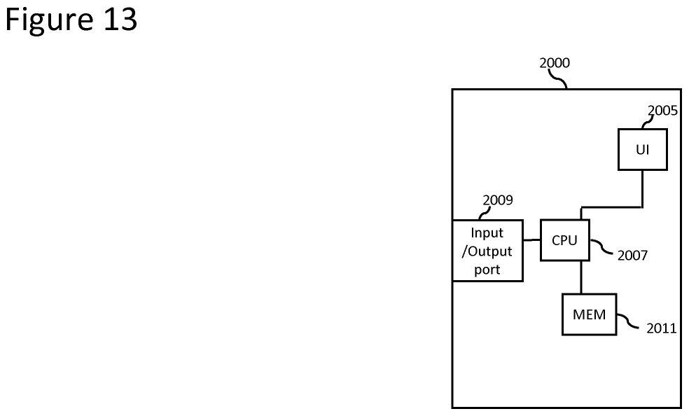

With respect to FIG. 13 an example electronic device which may be used as any of the apparatus parts of the system as described above. The device may be any suitable electronics device or apparatus. For example in some embodiments the device 2000 is a mobile device, user equipment, tablet computer, computer, audio playback apparatus, etc. The device may for example be configured to implement the encoder or the renderer or any functional block as described above.

In some embodiments the device 2000 comprises at least one processor or central processing unit 2007. The processor 2007 can be configured to execute various program codes such as the methods such as described herein.

In some embodiments the device 2000 comprises a memory 2011. In some embodiments the at least one processor 2007 is coupled to the memory 2011. The memory 2011 can be any suitable storage means. In some embodiments the memory 2011 comprises a program code section for storing program codes implementable upon the processor 2007. Furthermore in some embodiments the memory 2011 can further comprise a stored data section for storing data, for example data that has been processed or to be processed in accordance with the embodiments as described herein. The implemented program code stored within the program code section and the data stored within the stored data section can be retrieved by the processor 2007 whenever needed via the memory-processor coupling.

In some embodiments the device 2000 comprises a user interface 2005. The user interface 2005 can be coupled in some embodiments to the processor 2007.

In some embodiments the processor 2007 can control the operation of the user interface 2005 and receive inputs from the user interface 2005. In some embodiments the user interface 2005 can enable a user to input commands to the device 2000, for example via a keypad. In some embodiments the user interface 2005 can enable the user to obtain information from the device 2000. For example the user interface 2005 may comprise a display configured to display information from the device 2000 to the user. The user interface 2005 can in some embodiments comprise a touch screen or touch interface capable of both enabling information to be entered to the device 2000 and further displaying information to the user of the device 2000. In some embodiments the user interface 2005 may be the user interface for communicating.

In some embodiments the device 2000 comprises an input/output port 2009. The input/output port 2009 in some embodiments comprises a transceiver. The transceiver in such embodiments can be coupled to the processor 2007 and configured to enable a communication with other apparatus or electronic devices, for example via a wireless communications network. The transceiver or any suitable transceiver or transmitter and/or receiver means can in some embodiments be configured to communicate with other electronic devices or apparatus via a wire or wired coupling.

The transceiver can communicate with further apparatus by any suitable known communications protocol. For example in some embodiments the transceiver can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

The input/output port 2009 may be configured to receive the signals.

In some embodiments the device 2000 may be employed as at least part of the renderer. The input/output port 2009 may be coupled to headphones (which may be a headtracked or a non-tracked headphones) or similar.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general-purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. An apparatus for assisting spatial rendering in at least one acoustic environment, the apparatus comprising;
at least one processor; and
at least one memory storing instructions that, when executed with the at least one processor, cause the apparatus at least to:
determine a source-listener distance;
determine an attenuation parameter value, the attenuation parameter associated with the source-listener distance;
determine an average attenuation parameter value associated with at least one acoustic environment;
determine a compensated attenuation parameter value based on the average attenuation parameter value and the attenuation parameter value;
obtain an input signal; and
generate a late reverberation audio signal part with applying a reverberator to the input signal, the reverberator configured with the compensated attenuation parameter value to compensate within the reverberation level for the attenuation parameter value associated with the source-listener distance.

2. The apparatus as claimed in claim 1, wherein the instructions, when executed with the at least one processor, cause the apparatus to obtain acoustic environment geometry associated with the at least one acoustic environment, wherein the instructions, when executed with the at least one processor, cause the apparatus to determine the average attenuation parameter value based on the at least one audio environment geometry.

3. The apparatus as claimed in claim 2, wherein the instructions, when executed with the at least one processor, cause the apparatus to:
determine an average distance between two points in the at least one audio environment geometry; and
determine the average attenuation parameter value based on the at least one audio environment geometry based on the average distance.

4. The apparatus as claimed in claim 3, wherein the instructions, when executed with the at least one processor, cause the apparatus to apply one of:
a closed form expression to calculate the average distance of two points in a geometric shape associated with the at least one audio environment geometry; or
a sampling procedure to simulate possible source and listener positions in the at least one audio environment geometry.

5. The apparatus as claimed in claim 1, wherein the instructions, when executed with the at least one processor, cause the apparatus to receive the average attenuation parameter value.

6. The apparatus as claimed in claim 1, wherein the instructions, when executed with the at least one processor, cause the apparatus to:
receive the average distance of the at least one acoustic environment; and
determine the average attenuation parameter value associated with the at least one acoustic environment based on the received average distance.

7. The apparatus as claimed in claim 1, wherein the instructions, when executed with the at least one processor, cause the apparatus to:
receive attenuation parameter values associated with a plurality of sampled source-listener positions within the at least one acoustic environment; and
determine the average attenuation parameter value associated with the at least one acoustic environment based on an arithmetic or geometric mean of the received attenuation parameter values.

8. The apparatus as claimed in claim 1, wherein the instructions, when executed with the at least one processor, cause the apparatus to determine the attenuation parameter value based on the source-listener distance.

9. The apparatus as claimed in claim 8, wherein the instructions, when executed with the at least one processor, cause the apparatus to:
obtain at least one of the source or the listener position from metadata associated with the at least one audio environment; and
select between three dimension or two dimension at least one audio environment geometry when calculating the source-listener distance.

10. The apparatus as claimed in claim 1, wherein the instructions, when executed with the at least one processor, cause the apparatus to determine a source-listener distance dependent gain for the reverberator for compensating the average attenuation parameter value.

11. The apparatus as claimed in claim 1, wherein the instructions, when executed with the at least one processor, cause the apparatus to:
adjust a ratio parameter based on the average attenuation parameter value in the at least one acoustic environment; and
apply the reverberator to a part of the input signal, the part of the input signal based on a filter applied to the input signal configured with the ratio parameter or based on the ratio parameter.

12. The apparatus as claimed in claim 1, wherein the instructions, when executed with the at least one processor, cause the apparatus to obtain a bitstream, wherein the bitstream comprises information of the amount of average distance gain attenuation, wherein the instructions, when executed with the at least one processor, cause the apparatus to determine the average attenuation parameter value based on the information of the amount of average distance gain attenuation.

13. An apparatus for assisting spatial rendering in at least one acoustic environment, the apparatus comprising:
at least one processor; and
at least one memory storing instructions that, when executed with the at least one processor, cause the apparatus at least to:
obtain acoustic environment geometry associated with the at least one acoustic environment;
determine an average attenuation parameter value associated with the at least one acoustic environment; and
generate a bitstream associated with the average attenuation parameter value, wherein the bitstream is to be employed in assisting a configuration of a reverberator within the spatial rendering.

14. The apparatus as claimed in claim 13, wherein the instructions, when executed with the at least one processor, cause the apparatus to determine an average distance associated with at least one audio environment geometry, and wherein the instructions, when executed with the at least one processor, cause the apparatus to determine the average attenuation parameter value based on the average distance.

15. The apparatus as claimed in claim 14, wherein the instructions, when executed with the at least one processor, cause the apparatus to apply one of:
a closed form expression to calculate the average distance of two points in a geometric shape associated with the at least one audio environment geometry; or
a sampling procedure to simulate possible source and listener positions in the at least one audio environment geometry.

16. The apparatus as claimed in claim 14, wherein the instructions, when executed with the at least one processor, cause the apparatus to select between a three dimensional or two dimensional geometry when calculating the average distance between two points in the at least one audio environment geometry.

17. The apparatus as claimed in claim 13, wherein the bitstream comprises the average attenuation parameter value.

18. The apparatus as claimed in claim 13, wherein the instructions, when executed with the at least one processor, cause the apparatus to:
determine parameters for a diffuse-to-direct ratio control filter for the reverberator within the spatial rendering; and
adjust the parameters for the diffuse-to-direct ratio control filter based on the average attenuation parameter value, wherein the bitstream comprises the adjusted parameters for the diffuse-to-direct ratio control filter.

19. A method for an apparatus for assisting spatial rendering in at least one acoustic environment, the method comprising:
determining a source-listener distance;
determining an attenuation parameter value, the attenuation parameter associated with the source-listener distance;
determining an average attenuation parameter value associated with at least one acoustic environment;
determining a compensated attenuation parameter value based on the average attenuation parameter value and the attenuation parameter value;
obtaining an input signal; and
generating a late reverberation audio signal part with applying a reverberator to the input signal, the reverberator configured with the compensated attenuation parameter value to compensate within the reverberation level for the attenuation parameter value associated with the source-listener distance.

20. A method for an apparatus for assisting spatial rendering in at least one acoustic environment, the method comprising:
obtaining acoustic environment geometry associated with the at least one acoustic environment;
determining an average attenuation parameter value associated with the at least one acoustic environment; and
generating a bitstream associated with the average attenuation parameter value, wherein the bitstream is to be employed in assisting a configuration of a reverberator within the spatial rendering.

21-22. (canceled)
